(19) United States
(12) Patent Application Publication
(10) Pub. No.: US 2025/0339789 A1
(43) Pub. Date: Nov. 6, 2025

(54) HYBRID THERMAL - CHROMATOGRAPHIC SYSTEM FOR SIMULTANEOUS MINERAL PURIFICATION AND DESALINATION OF SALINE WATERS

(71) Applicant: Alliance for Sustainable Energy, LLC, Golden, CO (US)

(72) Inventors: Patrick Owen SABOE, Golden, CO (US); Ryan Lane PRESTANGEN, Golden, CO (US); Eric M. KARP, Denver, CO (US); Bryan PIVOVAR, Arvada, CO (US); Zbyslaw Roman OWCZARCZYK, Littleton, CO (US); Hoon CHOI, Lakewood, CO (US)

(21) Appl. No.: 19/087,176

(22) Filed: Mar. 21, 2025

Related U.S. Application Data
(63) Continuation-in-part of application No. 17/783,716, filed on Jun. 9, 2022.
(60) Provisional application No. 63/568,206, filed on Mar. 21, 2024.

(51) Int. Cl. B01D 15/18; C02F 1/26; C02F 1/28; C02F 101/12

(52) U.S. Cl. CPC B01D 15/185; B01D 15/1842; C02F 1/265; C02F 1/285; C02F 2101/12

(57) ABSTRACT

Lithium (Li) is a key element for clean energy technologies, and, accordingly, the global lithium demand has been increasing rapidly. Therefore, to meet the Li demand and keep supply chains stable, it is critical to develop efficient lithium extraction technologies that allow exploitation of unconventional lithium resources, such as geothermal brines and inland brine streams. However, the recovery of Li from these resources is challenging due to low Li concentration and high Li/Na, Li/Mg, or Li/Ca ratios. Disclosed herein are novel Zwitterionic Chromatography resins and methods of use for separating Li from salts and other ions.

### CROSS-REFERENCE TO RELATED APPLICATIONS

This application claims priority under 35 U.S.C. § 119 to U.S. provisional patent application No. 63/568,206 filed on 21 Mar 2024, the contents of which are hereby incorporated in their entirety This application is a continuation-in-part of U.S. patent application Ser. No. 17/783,716 filed on 09 Jun 2022.

### CONTRACTUAL ORIGIN

The United States Government has rights in this disclosure under Contract No. DE-AC36-08GO28308 between the United States Department of Energy and Alliance for Sustainable Energy, LLC, the Manager and Operator of the National Renewable Energy Laboratory. This invention was made with government support under grant no. DE-AC36-08GO28308 awarded by the Department of Energy. The government has certain rights in the invention.

### BACKGROUND

Most current approaches to recovering magnesium from seawater operate via conventional hydrometallurgical chemistry with targeted chemical precipitation is used as a means for selective separation of an insoluble magnesium salt. These selective precipitation approaches use added chemicals which increase cost and environmental footprint of the system and require large fresh-water usage due to the need to wash the precipitates that are formed. Other methods use exotic electrochemical methods that are not scalable and require large energy footprints if scaled to commodity level. To date none of these electrochemical approaches have seen commercial success at large scales needed for desalination operations.

Desalination is becoming a critical technology for mankind to meet the growing fresh water demands faced by climate change, economic, and population growth. Today, Reverse Osmosis (RO) is the state of technology, producing fresh water from saline feeds at a price point of about $1.00/m³. During plentiful years, runoff water from irrigation ditches can cost as little as about 0.08/m³, making desalinated water about 10 times more expensive than runoff water. The United Nations sets a target for desalinated water of about $0.25/m³, and the current RO technology is thus about 4× more expensive than where it needs to be to supply fresh water without resulting in significant economic disruption.

Existing methods and technologies for mining elements and salts of interest from brines and saltwater are expensive, are not robust, pollute the environment, are energy intensive and some only work on small scales. As an example, the current technology used for Salar mining consists of pumping underground brine rich in a target salt (e.g. LiCl) into open shallow ponds. Solar irradiation and strong winds concentrate this brine over a period of 10 months to 2 years into solutions containing greater than 5-6 wt % of LiCl. During evaporation KCl*MgCl₂.6H₂O and MgCl₂.6H₂O precipitate if Mg is present in the brine. This precipitation reduces LiCl yields by trapping some LiCl in the precipitate. Next lime is added to precipitate any additional Mg as Mg(OH)₂—CaSO₄*2H₂O this again lowers the LiCl yield by trapping some LiCl in the magnesium precipitate. Then The aqueous LiCl is filtered off and a carbonation step is employed using the addition of soda ash to precipitate battery grade Li₂CO₃ at about 90° C. This process is the standard hydrometallurgy approach to separating Li₂CO₃ from Salars and has an overall yield of about 50 to 70% depending on the magnesium to lithium ratio.

If the Mg:Li ratio is greater than 6:1 this approach is uneconomical because the yields of Li₂CO₃ become low and large amounts of lime are needed which is not feasible economically to transport into some of these remote areas. Additionally, the approach requires a large water footprint due to the need to wash the precipitates after filtering.

Another commonly used approach to mine elements and minerals of interest from brines or saltwater is the use of ion exchange materials. These adsorbents are designed to selectively bind to Li⁺ cations directly from the saline feed. Common ion exchange materials include spinel based Li—Mn—O oxides, Li—Ti—O oxides, and LiCl*₂Al(OH)₃ oxides. These adsorbents are different than standard ion exchange resins because their mode of operation consists of selective ion bonding of Li⁺ into the oxide structure rather than non-specific ion exchange that occurs on functionalized ion exchange resins. These materials allow the separation and recovery of Li from high Mg concentration brines and from lower concentration brines (<200 ppm of Li⁺). However, shortcomings of adsorption technology include the use of strong HCl solution used in the desorption process which is an added expensive chemical requirement, and this degrades the adsorbent over time. Additionally, a very large water footprint is required to rinse the adsorbent oxides after desorption with HCl. This is a challenging requirement to meet in the high alpine Salars of South America because fresh water is difficult to transport to these remote locations.

Other technologies have been investigated at the laboratory scale including membrane recovery, electrochemical methods, and liquid-liquid extraction. These methods are not yet suitable for application at scale. Membranes do not currently have the high selectivities required for pure Li⁺ recovery and fouling requires expensive replacements. Electrochemical methods, while highly selective, are not well suited for application at scale and are considered exotic by the mining industry. Liquid-liquid extraction requires the use of expensive organic extractants whose replacement is expensive, and there is a lack of efficient processes for the recovery of Li from the organic phase once extracted.

As another example of the lack of efficient and environmentally sustainable processes used to mine elements and salts from brines and saltwater is the mining of magnesium from saltwater. Most current approaches to recovering magnesium from seawater operate via conventional hydrometallurgical chemistry with targeted chemical precipitation is used as a means for selective separation of an insoluble magnesium salt. These selective precipitation approaches use added chemicals which increase cost and environmental footprint of the system and require large fresh-water usage due to the need to wash the precipitates that are formed. Other methods employ the use of exotic electrochemical methods that are not scalable and require large energy footprints if scaled to commodity level. To date none of these electrochemical approaches have seen commercial success at large scales needed for desalination operations.

### SUMMARY

In an aspect, disclosed herein is a method for the separation of salts from an aqueous solution comprising the use of SMB chromatography comprising the use of zwitterionic resins. In an embodiment, the method comprises the production of water. In an embodiment, the method includes the isolation of salts from an aqueous solution and isolating pure water by using multi-effect distillation (MED), MED and Mechanical Vapor Recompression (MED-MVR), Plug Flow RO (PF-RO), and state of the art Closed Circuit RO (CC-RO) methods.

### BRIEF DESCRIPTION OF FIGURES

FIG. 1 depicts an overview of an embodiment of a hybrid thermal-chromatographic system for the simultaneous fractionation and purification of salts and the recovery of purified water as disclosed herein.

FIG. 2A depicts a generalized synthesis method for producing quaternary ammonium (QA⁺) cations coupled to various anion groups such as carboxylate (CA), sulfonate (SO₃⁻), and phosphonate (PO₃⁻) groups tethered to a styrene divinyl benzene (SDB) resin backbone. FIG. 2B depicts a generalized synthesis method for imidazolium cation (I⁺) coupled to the anion groups shown in the blue box at various carbon spacings.

FIG. 3A depicts in-column isotherm measurements for various mineral salts to the (QA⁺)C3(SO₃⁻) resin. FIG. 3B depicts in-column isotherm measurements for various mineral salts to the commercially available (QA⁺)C1(CO₂⁻) Purolite resin.

FIG. 4A depicts 2-2-2-2 SMB configuration modeled in Aspen chromatography using the isotherm values and resin characterization values from FIG. 3A. FIG. 4B depicts concentration profiles of the six mineral salts at each zone in the SMB.

FIG. 5 depicts an embodiment of a conventional 4-zone SMB configuration.

FIGS. 6A and 6B depict a short pulse test with a mixture of five salts, NaCl, KCl, LiCl, MgCl₂, and CaCl₂ (5 g/L each) on (A) IMC3CA and (B) QAC3CA columns. Feed injection volume: 0.5 mL, flowrate: 2 mL/min, column i.d. and length: 1 cm×28 cm.

FIG. 7 depicts elution curves of NaCl, KCl, LiCl, CaCl₂, and MgCl₂ by loading 64 mL of brine and eluted water. The flowrate was 2 mL/min, column size was inner diameter of 1 cm×Lc 28.2 cm. Note that solid lines and dots are experimental data and the dashed lines are simulation data.

FIGS. 8A, 8B, 8C depict: FIG. 8A SMB configuration (2-2-2-2) studied in this system; FIG. 8B depicts SMB separation regime on m² and m³ plane for binary separation with (2-2-2-2) configuration based on the triangle theory for linear adsorption isotherm, and FIG. 8C depicts separation regime for the zSMB system with nonlinear adsorption isotherms. The cross mark in FIG. 8C indicates the operating parameters being used for FIG. 7.

FIGS. 9A, 9B, 9C, 9D depict: FIG. 9A scheme of SMB zone configuration, FIG. 9B column profiles of SMB at processing time 396 min (steady state), FIG. 9C effluent profiles at extract port, and FIG. 9D effluent profiles at raffinate port. Note that secondary y-axis show major or minor components' profile, separately.

FIG. 10 depicts a schematic overview of zwitterionic chromatography illustrating the interaction between ions and the stationary phase.

FIG. 11 depicts an embodiment of a synthesis procedure to prepare QA-based ZW stationary phase.

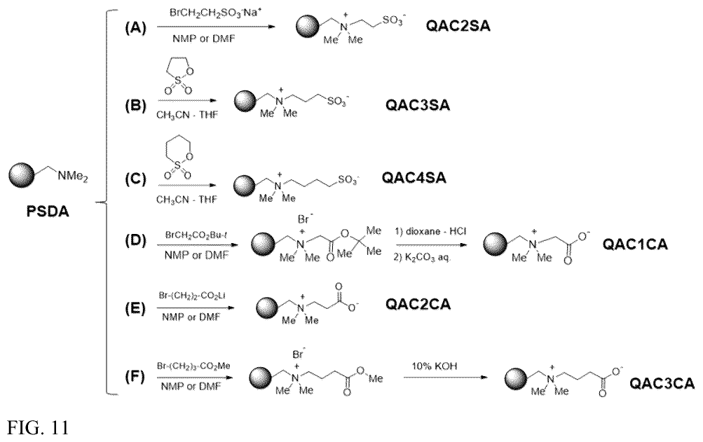

FIG. 12 depicts an embodiment of a synthesis procedure to prepare IM-based ZW stationary phase.

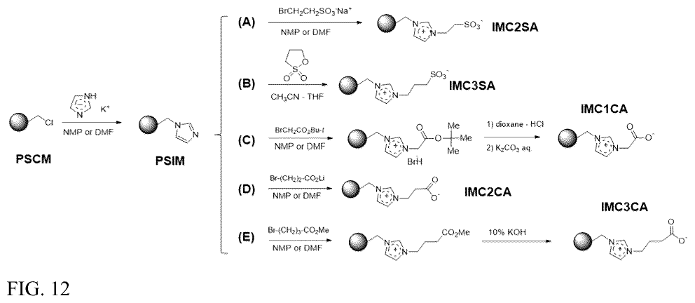

FIGS. 13A and 13B depict an embodiment of thermogravimetric analysis of prepared (A) QA-based and (B) IM-based ZI stationary phases.

FIG. 14 depicts an elemental analysis of an embodiment of prepared ZI stationary phase.

FIGS. 15A, 15B, 15C, and 15D depict Chromatograms of single pulse test on (A) QAC3CA, (B) QAC3CA, (C) IMC3SA, and (D) IMC3CA.

FIGS. 16A, 16B depict chromatograms of single pulse test of five salts on (A) QAC3SA (large pore) and (B) QAC3CA (large pore).

FIGS. 17A, 17B, 17C, 17D depict a retention factor (k′) of each salt (10 g/L) on the ZW stationary phase with varied carbon chain length: (A) QA-SA, (B) QA-CA, (C) IM-SA, and (D) IM-CA stationary phases.

FIGS. 18A, 18B, 18C, 18D depict (A) retention factor of each salt with varying concentrations and (B) separation of 10 g/L of NaCl and LiCl (Vinj: 6 mL) on QAC3CA under water elution, (C) retention factor of each salt with varying concentrations and (D) separation of 5 g/L of five mixed salts (Vinj: 0.5 mL) on IMC3CA under water elution.

FIGS. 19A and 19B depict an embodiment of a chromatogram for multicomponent separation of brine solution on IMC3CA using water elution. FIG. 19A depicts Smackover brine (Vinj: 0.5 mL) elution on IMC3CA (pore size 95 Å). FIG. 19B depicts a long loading test of pretreated brackish water (Vinj: 80 mL) on QAC3CA (pore size 10 Å).

FIG. 20 depicts the ionic (r), hydrated ionic radius (r+Δr), and the molar Gibbs free energy of hydration (Δ_hyd G) of ions.

FIGS. 21A through 211 depict simulated elution profiles with varied hydration reaction rates in the mobile phase (reversible).

FIGS. 22A and 22B depict the initial conformations of the ion migration simulation. Both Ca2+ (blue) and Cl− ions (green) are placed outside the 20 Å (A) and 50 Å pores (B).

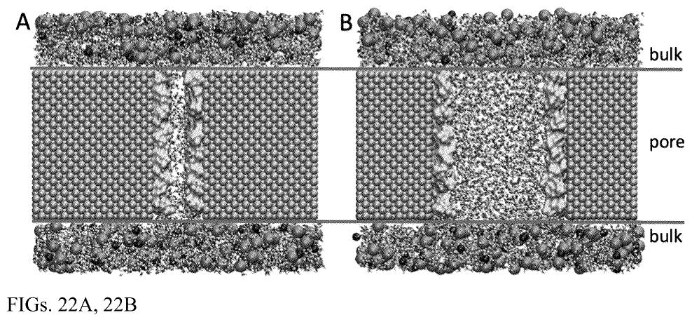

FIGS. 23A through 23F depict the amounts of cations present inside the 50 Å (A-C) and 20 Å (D-F) pores.

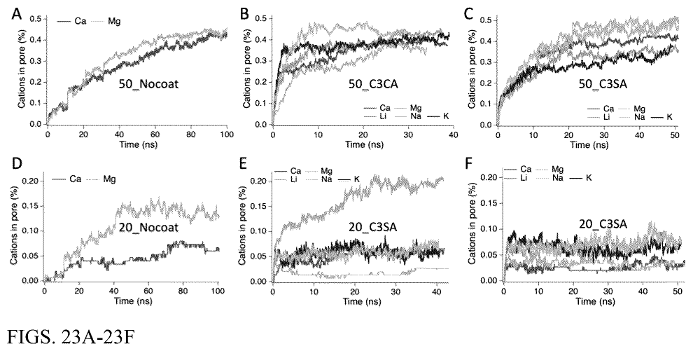

FIG. 24 depicts separation factors of Li/Ca and Li/Mg on various ZI stationary phase. The separation factor was calculated based on the salt retention on each stationary phase.

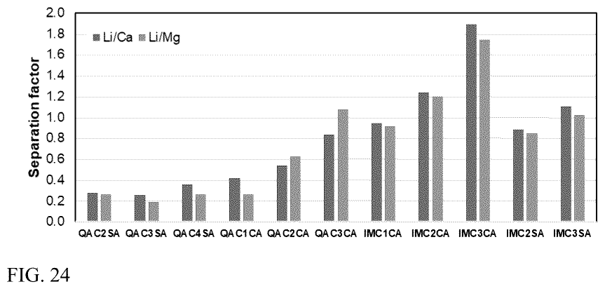

### DETAILED DESCRIPTION

Lithium (Li) is a key element for clean energy technologies, and, accordingly, the global lithium demand has been increasing rapidly. Therefore, to meet the Li demand and maintain supply chain stability, it is critical to develop efficient lithium extraction technologies that allow exploitation of unconventional lithium resources, such as geothermal brines and inland brine streams. However, the recovery of Li from these resources is challenging due to low Li concentration, low ratios of Li/Na, Li/Mg, or Li/Ca, and complex feed compositions. To address this, we introduced a new Direct Lithium Extraction (DLE) process using Zwitterionic Chromatography (ZIC) to separate Li from other salts. Since salts are partitioned on ZIC under water elution, no reagent chemicals are needed, and the Li separation is not limited by the adsorption capacity. We prepared 13 different zwitterionic (ZI) resins to investigate the salt retention on various ZI groups and then screened out promising sorbents for efficient Li separation. It was found that salt retention was synergistically affected by the pore size and ZI configurations. Using carboxybetaine (QAC3CA) sorbents, multicomponent separations showed that Li can be partitioned from divalent salts or Na with selectivities of 1.8 or 1.9, respectively. Although the selectivity is relatively low, in real brine tests, Li was separated from Ca and Mg with 79.2% yield, showing the potential for a continuous process to achieve high productivity and high yield. Simulation studies suggest the salt elution mechanism is related to the hydration reaction energy and the effective hydrated radius of cations.

Disclosed herein are methods and compositions used to synthesize and use novel zwitterionic chromatographic resins for the separation and purification of lithium and other salts from unconventional resources (e.g., geothermal brines and oil and gas formation waters). Embodiments of the hybrid thermal-chromatograph systems described herein solve the co-product generation problem associated with seawater desalination, and result in significant reduction in the selling price of fresh water generated through the process, while also solving problems associated with traditional lithium mining practices. Specifically, the systems and methods disclosed herein separate individual ions from saline solution using only water as an eluent. When fractions are continuously collected in a simulated moving bed (SMB) format, the purified salts are recovered through heat integrated water removal technology (e.g. multi-effect distillation (MED) or mechanical vapor recompression (MVR)).

Without being limited by theory, zwitterionic chromatography operates by whole salts intercalating between the positive and negative charges on zwitterions tethered to a resin backbone. As a mixed-salt solution (brine) moves downward through the column, individual salts separate from one another based on their differing affinities with the stationary-phase zwitterion. For example, LiCl is a small, charge-dense salt that has minimal interaction with the stationary-phase zwitterion, but MgCl₂ has a divalent charge with a greater interaction with the stationary-phase zwitterion and is thus slowed to a greater extent than LiCl as it moves down through the column. These differing interactions that salts have with the stationary-phase zwitterion are the driving force for their separation. The stationary-phase zwitterion can be tuned to achieve maximum separation (resolution) of LiCl from the other salts. Compared to traditional IX used in direct lithium extraction (DLE) zwitterionic chromatography requires no addition of mineral acid, reducing OPEX; has greater throughput because it can be run continuously; and has the potential to separate many types of valuable mineral salts, for example LiCl. When separation factors (generally >1.5) are achieved for LiCl from the other salts in a batch column experiment, then the process can be scaled in an SMB.

In contrast to conventional ion exchange (IX), zwitterionic chromatography operates chromatographically using only water as the eluent and thus requires no added chemicals. This improves environmental stewardship and decreases operating expenses (OPEX) compared to currently practiced DLE technology. Additionally, an increase in resin lifetime is demonstrated herein because mineral acids—which often reduce resin durability—are not used. Increased throughput and increased yields using zwitterionic chromatographic methods and compositions disclosed herein are also demonstrated. In an embodiment, the zwitterionic chromatography disclosed herein is useful for mineral recovery. Zwitterionic chromatography methods and compositions disclosed herein are useful to fractionate not just LiCl, but many mineral salts simultaneously (e.g., MnCl₂, CoCl₂) that may also be present in the input brine. This allows a more universal stationary phase for the recovery of minerals from saline resources simply by changing the switching sequence of the SMB, which can be done on the fly with the SMB software. In contrast, IX technology packs the columns with adsorbent specifically designed to selectively remove a single cation (e.g., Li⁺). If the operator wishes to recover a different mineral in the resource (e.g., Co2⁺), a new process with different adsorbent is used using methods and compositions disclosed herein.

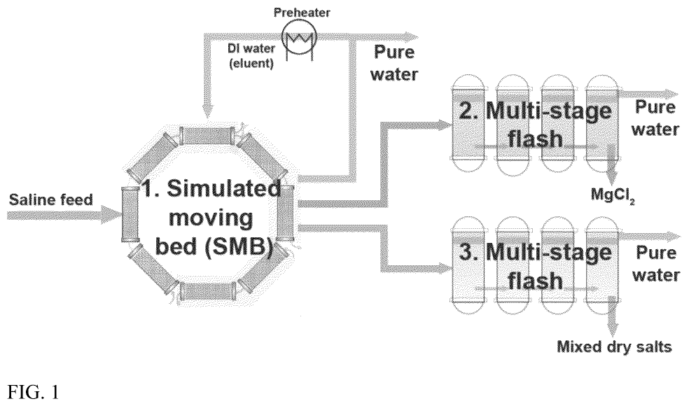

In an embodiment, the method disclosed herein consists of a process that receives seawater or other brine solutions as a feed and chromatographically fractionates the dissolved ionic compounds into purified fractions. The fractions consist of a pure water cut, and mixed salt cuts that each consist of single ionic pair compound dissolved in water, and, potentially, a mixed ionic component fraction. In an embodiment, the eluent used in the chromatographic separation is fresh water which increases the sustainability and scalability of this process. In post-chromatographic fractionation, water is removed from each saline fraction via a thermal process such as multistage flash, mechanical vapor recompression, and/or multi-effect distillation. This leaves purified dry salts and fresh desalinated water as products. FIG. 1 depicts an embodiment of this process. Purified metals can then be recovered from the dry salts via known technology such as electrowinning.

The present disclosure may address one or more of the problems and deficiencies of the prior art discussed above. In an embodiment, using methods disclosed herein various elements, minerals and salts including the following, for example, can be separated efficiently from salt water, brine or any aqueous solution: cobalt, lithium, magnesium, rare earth elements group, strontium, tin, tungsten, zirconium. In an embodiment the rare earth elements group consists of cerium, dysprosium, erbium, europium, gadolinium, holmium, lanthanum, lutetium, neodymium, praseodymium, promethium, samarium, scandium, terbium, thulium, ytterbium, and yttrium. In an embodiment, a zwitterionic stationary phase is synthesized and scaled, able to handle very hard resource waters, and it is capable of fractionating many minerals salts simultaneously, allowing flexibility in mineral recovery targets.

Using methods disclosed herein, improvements over existing desalination or elemental harvesting include a reduced CO₂ footprint, reduced consumption of chemicals, reduced waste generation, and reduced energy demand.

In an embodiment, methods for development and synthesis of new zwitterionic ion exchange materials are disclosed herein. In an embodiment the zwitterionic ion exchange materials are packed, characterized, and tested at both small and large scale and are further mathematically modeled in an SMB system in Aspen Chromatography using determined resin and column parameters. Disclosed herein are methods for material performance and selection for a multi-column system setup in an 8, 16 or more, column SMB system.

In an embodiment, the chromatographic fractionation step is performed using a zwitterionic (a.k.a. amphoteric) resin that interacts with the entire ionic compound as it moves through the column. A benefit of the zwitterionic media is that the eluent used is pure water rather than a buffered solution commonly used in ion chromatography approaches. This differs from zwitterionic chromatography used in embodiments disclosed herein that is sometimes referred to as “ion pair” chromatography or extraction chromatography of ionic compounds.

The methods and embodiments disclosed herein allow some or all of the pure-water cut obtained from the SMB chromatographic separation to be recycled back to the chromatographic process for reuse as the eluent (see FIG. 1) and substantially adds to lowering the environmental footprint of the system since no waste salts are generated, which is in contrast to ion chromatography approaches that use buffered solutions as a eluent. An ionic compound such as sodium chloride (NaCl) interacts with the zwitterionic resin as it chromatographs down the column. This “ion pair” chromatographic effect allows fresh water to be used as the eluent eliminating the need for a buffered solution to be used as the eluent. The chromatographic fractionation step is scaled into a continuous process through the use of a SMB that can process thousands of cubic meters of saline water (or more) per day. The switching sequence of the SMB system can be modified to collect pure cuts of any of the ionic compounds provided their separation factors are high enough. Mixed cuts containing multiple ionic species can also be obtained by widening the collected fractions with the SMB switching sequence. Additionally, fresh-water cuts can also be collected by adjusting the switching sequence to collect fractions between the ionic peaks. Each peak position can be measured in real time using an online conductivity detector or in some cases a UV detector.

In an embodiment, the ability of the zwitterionic resins used in SMB chromatography to separate depends upon the length of the alkane or other monomeric units that make up the polymer comprising the zwitterionic chains as well as the nature, identity and number of ionic species that make the resins zwitterionic. For example, and without being limiting, the zwitterionic groups may include phosphate, quaternary amines, amides, carboxylic acids, amines and other functional groups which may be ionized at various aqueous pH ranges.

In and embodiment, disclosed herein are zwitterionic resins useful in SMB chromatography with different zwitterionic functional groups made using different synthesis methods. In an embodiment, zwitterionic resins were developed for 2% cross-linked polystyrene divinylbenzene resin (200-400 mesh). In an embodiment, the functional group of the zwitterionic resins are quaternary amine—1 carbon linkage—carboxylate (R—N+(CH₂)₂—CH₂—COO—). In an embodiment, the functional group of the zwitterionic resins are quaternary amine—3 Carbon linkage—carboxylate (R—N+(CH₂)₂—(CH₂)₃—COO—). In an embodiment, the functional group of the zwitterionic resins are quaternary amine—3 Carbon linkage—Sulfonate (R—N⁺(CH₂)₂—(CH₂)₃—SOOO⁻)−QAC3SA. In an embodiment, the functional group of the zwitterionic resins are imidazolium—1 carbon linkage—carboxylate (R—N₂⁺(CH₂)₃—CH₂—COO—)−IMC1CA.

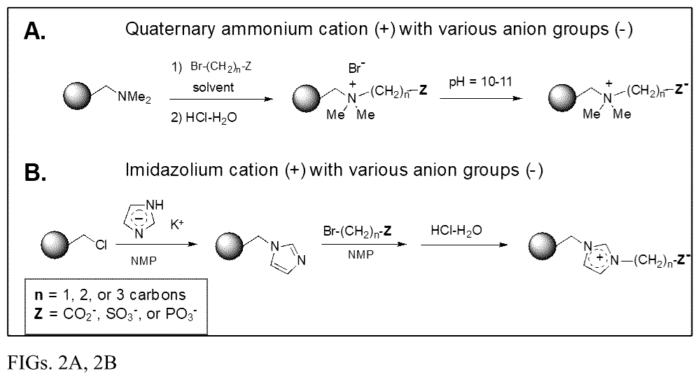

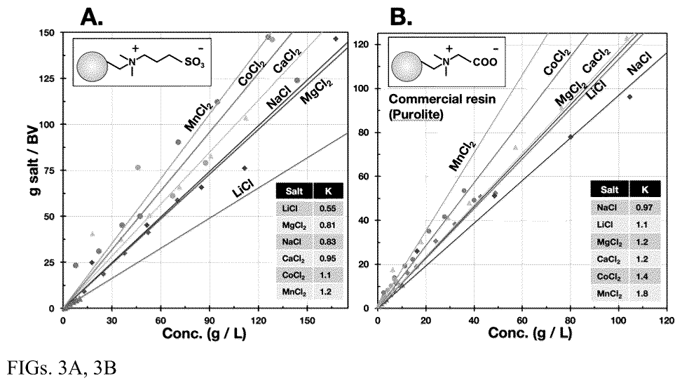

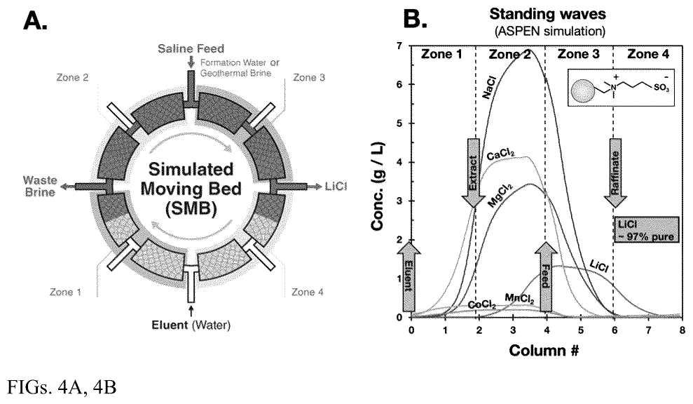

Synthesis methods are described herein and, in an embodiment, in FIG. 2. Approximately 20 g of each of these functionalized resins have been produced on a backbone sourced from NetQem, LLC. In addition, approximately 20 g of three of these resins have been produced on a backbone sourced from Sigma Aldrich. Resin characterization methods include particle size analysis, elemental analysis, ion exchange capacity analysis, and water uptake measurements by dynamic vapor sorption. Each resin was packed in a small column. Analytes tested include the chloride salts of lithium, magnesium, sodium, calcium, cobalt, and manganese. Column characterization methods include equilibrium isotherm testing, void volume measurements, and analyte retention measurements. Equilibrium isotherm measurements are shown in FIG. 3. Single column modelling and SMB modelling is performed in Aspen Chromatography. The single column models are used to determine size exclusion and intra-particle diffusivity parameters for each analyte. The standing wave design theory for SMB design is used to estimate the operating conditions and port switching sequence for the SMB simulation. The SMB simulation results in predicting system productivity, raffinate and extract port profiles, and the standing wave design profile at steady state. Standing wave plots are shown in FIG. 4.

Disclosed herein are robust and scalable synthesis procedures to produce preparative quantities of zwitterionic resins. FIG. 2A shows the general synthesis method for quaternary ammonium (QA+) cations connected to various anions such as a carboxylate (CA−) group, sulfonate (SO₃−) group, or phosphonate (P−) group. The chemistry for this synthesis reacts a weakly basic dimethylamino styrene divinyl benzene (SDB) resin with brominated intermediates in an alcohol solvent. The brominated intermediates take the form of Br—(CH₂)n-Z, where N is 1, 2, or 3 and Z is one of the anion groups listed above. This reaction takes approximately 3-12 hours (dependent on the Z group) at 90° C. and produces the QA+ zwitterionic resin functionalized with the Z group in its ester form.13 Then, HCl and water at pH<3 is added to liberate the alcohol ester and form the acidic Z group. However, because the pH of the solution is less than 3, the anion on the resin is in its protonated form. Thus, the final step is raising the pH to 10-11 with the addition of NaOII. This produces the QA+ and Z-zwitterionic resin. The resin is then filtered from the solution, washed with water, and placed in a 40° C. vacuum oven for 24 hours to produce a dry resin that can then be used to pack into columns and used in a SMB system. To synthesize the zwitterionic resins with imidazolium (I+) cations connected to CA−, SO₃−, or P− anion groups, a chloromethylated SDB resin is used as the starting material. The chloromethylated SDB is reacted with potassium imidazolide in N-methyl-2-pyrrolidone (NMP) at room temperature to produce the SDB resin functionalized with imidazolide (FIG. 2B). Then the brominated intermediate, Br—(CH₂)n-Z, is added, followed by acidification with the addition of water and HCl in the same way as described previously for the QA+ zwitterion synthesis. This yields the imidazolium cation (I+) tethered to various anion groups at carbon spacings dictated by the brominated intermediate used (FIG. 2B).

The synthetic approaches depicted in FIG. 2 allow for the production of multiple zwitterionic resins. The synthetic methods disclosed and used herein are very scalable, and can be used to produce, in an example, greater than 5 kg of resin. In an embodiment, the dimethylamino SDB resin and the chlorinated version starting materials may be purchased in bulk. Additionally, they be purchased with a variety of mesh sizes (particle diameters) and pore sizes. In an embodiment, the resins have 40-80-μm diameters. In an embodiment resins of these diameters are able to minimize bandspreading during batch chromatography while maintaining a pressure of about 4 bar, which is below the 5-bar limit for general SMB equipment.

In an embodiment, after being synthesized using methods disclosed herein, the zwitterionic resins are then packed into columns for batch chromatography experiments to measure pore size and equilibrium adsorption isotherms for mineral salts of interest. Pore size measurements are made “in column,” where pulses of undyed Dextran 2000 are passed through the bed. The Dextran 2000 pulse allows the measurement of the void space between the resin beads in the column because Dextran 2000 is too large to enter the pores of the resin. Next, the total porosity of the column is measured by pulsing D₂O through the column, which can enter both the pores and the void space. The particle porosity can then be back calculated from these two measurements. The particle porosity is useful measurement for SMB modeling work and it also varies significantly as zwitterion chain length increases (see FIG. 2) because the longer zwitterionic groups crowd the pores and effectively shrink their size. Smaller pores can generate a secondary “sieving” effect of ions that may increase their resolution, but if they are too small then ions are excluded from entering them. Lastly, “in-column” isotherms are measurements made to quantify the differences in affinity for different minerals to the zwitterionic resins. These measurements are made through standard procedures and provide a driving force for resolution of minerals from one another.

FIG. 3 displays equilibrium adsorption isotherm results of synthesized (QA⁺)C3(SO₃−) zwitterionic resin (see FIG. 3A) compared to the only commercial zwitterionic resin available—a (QA+)C1(CA−) material from Purolite (WCA100 resin) (see FIG. 3B). Both resins had measured functional group densities of 3-3.7 mEq/g. The slopes of the lines in FIG. 3 are the equilibrium constants for each mineral salt. The resin synthesized using methods and compositions disclosed herein is able to resolve MnCl₂, CoCl₂, CaCl₂, and LiCl from a mixed brine due to the differences in equilibrium adsorption constants. This is in contrast to the commercial (QA⁺)C1(CA⁻) resin, which is not capable of resolving LiCl from MgCl₂ or CaCl₂. The results depicted in FIG. 3 demonstrate that the materials disclosed herein are capable of separating minerals (namely LiCl) from brines at a level of fidelity that commercially available materials cannot achieve. In an embodiment, the optimum spacing between charge groups for maximum salt separation is C2 based on the hydrated ion sizes, and thus the level of separation shown in FIG. 3A can be improved even further.

In an embodiment, greater than 15 g of 18 different zwitterionic resins (such as those depicted in FIG. 2) can be synthesized to test for mineral separation in batch mode. In an embodiment, these resins are QA+ and CA− functional group resins tethered to an SDB backbone separated by 1, 2, and 3 carbons; QA+ and P− functional groups separated by 1, 2, and 3 carbons; and QA+ and SO₃− functional groups separated by 1, 2, and 3 carbons using synthesis methods as disclosed herein, see, for example, FIG. 2.

In an embodiment, the resins synthesized using methods disclosed herein can be used to make gram and kilogram quantities of each of QAC1CA, QAC2CA, QAC3CA, QAC1PO₃, QAC2PO₃, QAC3PO₃, QAC1SO₃, QAC2SO₃, and QAC3SO₃ resins.

In an embodiment, the resins synthesized using methods disclosed herein can be used to make gram and kilogram quantities of each of IC1CA, IC2CA, IC3CA, IC1PO₃, IC2PO₃, IC3PO₃, IC1SO₃, IC2SO₃, and IC3SO₃ resins.

In an embodiment, the characterization of the synthesized resins can be performed to determine functional site density through reaction synthesis mass yields, CHN analysis, and IEC measurements. Pore size measurements of the synthesized resins can be performed by using Brunauer-Emmett-Teller (BET) isotherms, swelling tests, and tracer pulse tests in batch mode.

In an embodiment, the IEC, CHN analysis, and reaction synthesis mass yields for the resins made using methods disclosed herein result in metrics for bed porosity and estimated pore size from tracer study using D2O and Dextran 2000 as tracers, BET measurements, and/or swelling tests.

In another embodiment, match testing with model salt solutions can be performed to determine resin K_{D} values for LiCl, CoCl₂, MgCl₂, MnCl₂, and at least one other dominate mineral present in samples. In an embodiment, the separation in K_{D} must be large enough to generate separation factors >1 LiCl and CoCl₂ from divalent ions. In an embodiment, bed porosities are greater than 0.35.

In an embodiment, the zwitterionic resins disclosed herein have a half-life of at least 2 years at 90° C. operating temperatures.

The ability to separate LiCl, MnCl₂ and CoCl₂ simultaneously using methods and compositions of matter disclosed herein is depicted in FIG. 3A and demonstrates the capability of the resins and methods to be used for the recovery of many different minerals from a saline resource. This is in contrast to IX technology in which stationary phases are specially designed to adsorb a single cation. For example, in DLE, IX resins such as aluminum compounds, spinel-type manganese-oxide-based adsorbents, and modified cation-exchange resins are used and can only be used for recovery of Li+. The zwitterionic resins and methods of use disclosed herein can be used to separate many salts simultaneously from brines that results in mineral recovery.

In an embodiment, the isotherm results depicted in FIG. 3 and characterization data are used to build a full-scale model of a continuous SMB process in the Aspen chromatography package to predict critical parameters such as yield, purity, and throughput needed for techno-economic analysis (TEA) and for benchmarking this technology to DLE. This model is also used to predict a switching sequence that will be used for continuous SMB demonstration runs. The Aspen simulation solves a complex set of coupled partial differential equations that account for equilibrium interactions and mass transfer effects down the column and it requires the input of particle porosity, radius, and equilibrium constants for all components in the feed, as well as the column geometry. The equations are increasingly difficult to solve as the number of components in the feed increases and as the zone configuration increases in complexity. The system was solved for all six components in FIG. 3A for the (QA+)C3(SO₃−) zwitterionic resin using the measured values to generate a switching sequence for continuous LiCl recovery. The results of this simulation are depicted in FIG. 4 where standing waves for all salts are produced. This is beneficial for the SMB to work at large scales. LiCl produces a standing wave that comes out first at a purity of about 97% in a standard 2-2-2-2 column configuration. The simulation results from Aspen chromatography in FIG. 4 assume a basic SMB setup that can result in greater than 99% purity by solving this system for SMB configurations with additional columns in each zone. In an embodiment, a 3-3-3-3 column configuration can be used to get greater than 99% purity.

FIG. 4B also depicts an advantage of the zwitterionic chromatographic technology disclosed herein compared to conventional IX in handling hard minerals: high concentrations of hard minerals such as CaCl₂ and MgCl₂ are separated from LiCl without fouling the resin. Without being limited by theory, this is because the zwitterion does not bind or chelate the 2+ ions as some IX resins do, but these ions still exhibit a greater interaction with the zwitterion than LiCl, slowing them at a greater rate.

In DLE, IX resins selectively adsorb Li+ ions that must be eluted from the column with hydrochloric acid, and that acid is an added chemical cost that also reduces resin lifetimes and must be remediated at an additional cost. In contrast, the zwitterionic SMB operates chromatographically using only water as the eluent and thus requires no added chemicals and increases throughput. This improves environmental stewardship and reduces OPEX. Additionally, the data depicted in FIG. 4 demonstrate that this resins and methods disclosed herein have the ability to withstand and be used in saline waters with concentrations of hard minerals above what IX can handle. Thus, in an embodiment, very hard resource waters for LiCl extraction may be used to isolate LiCl. As an example, water in the Bryans Mill, Texas, area contains about 2.5 g/L of LiCl but also contains 78 g/L of CaCl₂ and 11 g/L of MgCl₂. The level of hardness of this resource is so great that current DLE technology cannot exploit it for LiCl recovery. However, zwitterionic chromatography methods and compositions disclosed herein could be used for LiCl recovery.

In an embodiment, the lifetime of the resins disclosed herein have a lifetime of about 8 to 10 years. Most IX resins used in DLE have a lifetime of about 5-8 years. In another embodiment, the zwitterionic materials disclosed herein could have a lifetime of 8-10 years because no mineral acid is used that has a tendency to degrade IX materials and the operating conditions using methods disclosed herein are mild, using only water as the eluent at room temperature and pressures less than 5 bar.

Advantageous properties of the zwitterionic resins used in chromatography as disclosed herein are depicted in Table 1.

TABLE 1
Metrics for zwitterionic chromatography
technology baselined to DLE.

| | | Zwitterionic |
|---|---|---|
| Metric | DLE (Baseline) | Chromatography |
| LiCl productivity | ~0.3 min⁻¹ | >0.1 min⁻¹ |
| | | (factor of >1.5) |
| LiCl yield (single pass) | 70%-90% | >90% |
| LiCl purity (single pass) | ~80% | >99% |
| OPEX (IX) | ~$5.07/ton of brine | >30% reduction |
| Resin lifetime | 4-8 years | >5 years |

In an embodiment, the zwitterionic SMB systems disclosed herein can be used to process a minimum of 20 gallons of water containing LiCl to obtain greater than 100 g of purified LiCl from the continuous SMB.

In another embodiment, LiCl is purified from brine using the novel zwitterionic resins and chromatography disclosed herein and can produce a continuous, high purity (>97% LiCl) product stream. In an embodiment, a 16-column XPure SMB system and a Cytiva Akta Pure 25 system are used with the zwitterionic resins and methods disclosed herein. In another embodiment, greater than 99% pure LiCl may be isolated from brines containing various different salts by using systems, methods and compositions disclosed herein.

In an embodiment, methods disclosed herein use SMB chromatography and zwitterionic resins that desalinate and chromatographically fractionate minerals simultaneously. SMB chromatography is different from ion exchange chromatography at least in so far as SMB chromatography uses warm water as an eluent; exhibits an entropy decrease that is driven by pressure from about 3 to about 5 bar and a temperature from about 70 to about 90° C.

The separation capabilities of resins disclosed herein are affected by resin properties including, but not limited to, the charge to distance ratio as it relates to separation factors, the ionic strength of charge centers, and the pH at which the resin is operated.

Operational parameters that affect the separation capabilities of the resins disclosed herein include the temperature, pressure and flowrates at which the resins are operated.

Advantages of using the SMB chromatographic methods disclosed herein include completely removing Mg, Na, and B using no added chemicals, at lower costs and the ability to use brines with high Mg and other ion concentrations. For example, in an embodiment, magnesium chloride salt is separated from other dissolved salts chromatographically through interaction with the zwitterionic media in a SMB using water as an eluent. Other dissolved salt can also be collected in purified fractions. As a metal, magnesium can then be recovered from the purified salt through known technology such as electrowinning.

In an embodiment, the cost associated with desalination is decreased by co-product generation of a purified metal salts to offset the cost of the desalinated water. In an embodiment, magnesium can be harvested from seawater. Magnesium chloride is present in seawater at approximate 1200 ppm and has thus been the target of many combined desalination and mining technologies to recover it as a coproduct. Magnesium metal has a value over $3000 per ton. This high price point of magnesium is currently driven by demand in the automotive sector for producing the next generation of lightweight alloys that incorporate magnesium.

In an embodiment, post-SMB chromatography relies on thermal dewatering of the separated fractions. Thermal desalination with heat integration techniques is a known approach that is cost competitive with RO technology due to the increased water yields and the current low cost of electricity. For example, Table 2 lists selling prices associated with multi-effect distillation (MED), MED and Mechanical Vapor Recompression (MED-MVR), Plug Flow RO (PF-RO), and state of the art Closed Circuit RO (CC-RO) systems. All of these commercially deployed desalination technologies produce desalinated water at a price point of about $1.00/m³. Despite state-of-the-art RO systems such as CC-RO that have very low energy consumption (about 2 kwh/m³), RO only has a 50% water yield and the current cost of electricity is relatively low making the electricity consumption of a desalination process a small driver of overall cost (see Table 2). This is an economic concern and it has been suggested that energy efficiency should not be a research focus since gains in energy efficiency to not, to a large extent, lower the selling price of the produced water.

TABLE 2

| | | Energy | Practical | |
|---|---|---|---|---|
| Desalination | Selling | consumption | energy limit | |
| tech | price ($/m³) | (kwh/m³) | (kwh/m³) | ZLD? |
| MED | $0.88-1.16 | 6.5-11 | ~3 | yes |
| MED-MVC | $0.92-1.32 | 6-10 | ~3 | yes |
| PF-RO | $0.99-1.09 | 3-5.5 | 1.1 | no |
| CC-RO | $0.90-1.07 | 2.1 | 1.1 | no |

Overall, the methods disclosed herein allow for separation of any purified metal salt before a thermal dewatering step using a simulated moving bed without the consumption of any ancillary chemicals. The thermal desalination step does not add significant cost to the system as shown in Table 2 and discussed above in the context of desalination. An advantage of embodiments as disclosed herein is the production of a coproduct salt that significantly adds value and thus lowers the overall selling price associated with the produced fresh water. SMB technology is scalable and when designed with the ion pairing chromatography approach disclosed herein allows for a massively scalable and economical approach to fractionation whole ionic compounds from saline feeds using no added chemicals. Furthermore, the methods disclosed herein allows for mining of saline feeds, in general, for valuable metal salts using only water and thermal energy as an input. This approach significantly lowers the overall economic footprint of the system compared to traditional hydrometallurgical and ion exchange approaches for saline water mining and is likely to be far greener than conventional strip-mining approaches for metals derived from ores.

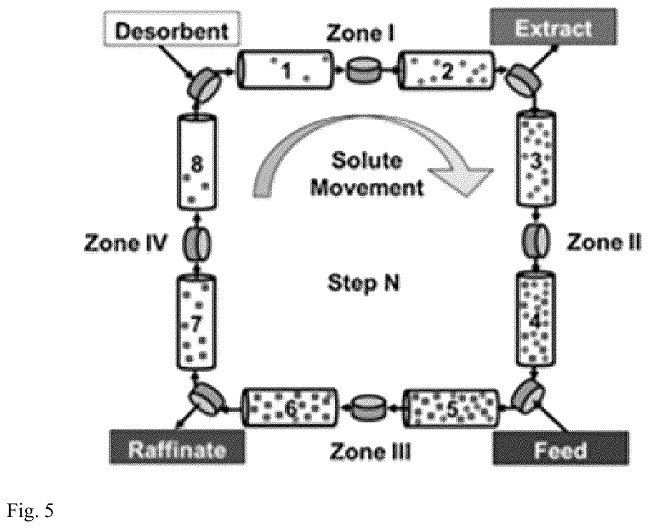

Disclosed herein are methods and compositions of matter useful for synthesizing, systematically testing, and scaling novel zwitterionic chromatographic resins for the separation and purification of lithium salts from unconventional resources (e.g., geothermal brines and oil and gas formation waters). An SMB is a scalable form of continuous chromatography where columns are connected in series together to form a loop (FIG. 5). This allows continuous injection of feed material and continuous removal of product as the constituents of the feed migrate around the loop. A switching sequence is constructed and timed to allow continuous removal of purified product as it migrates around the loop. Today, SMBs are used with commercialized adsorbents at the commodity scale (processing up to ˜200,000 m³/yr in the largest systems). Some examples of commodity scale separations using an SMB are the separation of paraffins from kerosene to produce Jet A fuel, sugar from cane syrup, and xylenes from racemic solutions. At the smallest lab scales bench top SMBs typically process 100 g-1 kg of feed per day. The technology is aimed to be a paradigm shift from Ion Exchange (IX) because the zwitterionic stationary phase is easily synthesized and scaled, able to handle very hard resource waters, and it is capable of fractionating many minerals salts simultaneously allowing flexibility in mineral recovery targets beyond just LiCl.

In an embodiment, disclosed herein are methods useful for multicomponent separations using the most promising sorbent, QAC3CA, in order to develop a SMB process to achieve 22 99% purity of Li separated from divalent salts.

Promising sorbents were selected based on the Li/Mg and Li/Ca selectivities, which were IMC3CA and QAC3CA. As shown in FIG. 1, a salt mixture loading test on both IMC3CA and QAC3CA columns showed different retention of salts. The online conductivity signal showed two peaks on IMC3CA while three peaks on QAC3CA. The monovalent salt analysis showed the first peak was mainly attributed to monovalent salt and the second peak must be mainly divalent salts (FIG. 5A). On the other hand, the retention of LiCl was longer than that of monovalent salts but shorter than that divalent salts (FIG. 5B), indicating higher selectivity of LiCl among major compounds in brine. For this reason, we selected QAC3CA as a promising sorbent for SMB process.

### Verification of Intrinsic Parameters With the Long Feed Loading Test

To optimize SMB process, the adsorption and mass transfer parameters are need to be measured in a batch loading test. Then, SMB simulations with the obtained parameters can be used to predict the yield, purity, and productivity of target products in the SMB process. Since a feed loading test with a large volume on a batch system shows a feasibility of separations in SMB process and it can be used to verify the adsorption and mass transfer parameters, a 64 mL (2.9% of CV) of real brine sample provided by Standard Lithium was loaded on the QAC3CA column (column volume 22 mL) and then eluted with water to obtain frontal and desorption curves of each component. The effluent fractions were collected and analyzed by HPLC-CAD methods that we recently developed for quantifying cations in brine samples.

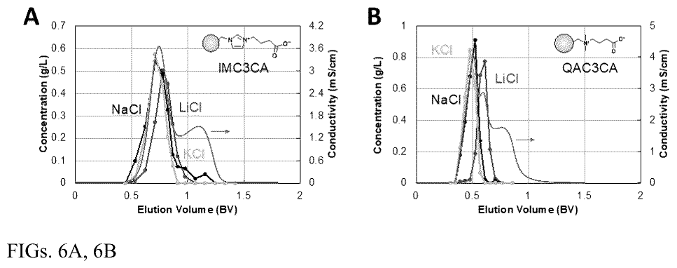

FIG. 6 shows elution curves of major compounds, NaCl, CaCl2, KCl, MgCl2, and LiCl from the brine loading test. The elution order was consistent with single pulse test results reported in the previous quarters. LiCl front showed in between NaCl and divalent salts, showing the feasibility of separating LiCl from divalent salts. It was noted that there was no evidence of adsorption of LiCl and other salts from batch adsorption tests, however, LiCl and NaCl interestingly showed a rolled-up front, indicating adsorption competition among salts. Also, the desorption curve of LiCl appeared at almost the same time as that of NaCl although the LiCl front was eluted later than that of NaCl. Additionally, the adsorption and desorption curves of divalent salts, CaCl2 and MgCl2, appeared at the same time. To simulate this process, the adsorption isotherms for these species were estimated by calculating the retention factors based on the solute movement theory and slightly adjusted to match the adsorption fronts. The simulation parameters are listed in Table 3.

TABLE 3
Simulation parameters used in FIG. 6.

| | | Size | Langmuir | Langmuir | | Intrparticle |
|---|---|---|---|---|---|---|
| | Feed | exclusion | isotherm | isotherm | Diffusivity | Diffusivity |
| | concentration | factor | factor* | factor* | (D_{b}, | (Dₚ, |
| Component | C_{feed} (g/L) | (Kse) | (aᵢ) | (bᵢ) | cm²/min) | cm²/min) |
| CaCl2 | 94 | 1 | 1.82 | 0.02 | 1e−3 | 5e−4 |
| KCl | 1.2 | 0.59 | 0 | 0 | | 9e−4 |
| LiCl | 1.5 | 1 | 0.38 | 0.01 | | 1e−3 |
| MgCL2 | 13.7 | 1 | 1.78 | 0.03 | | 5e−4 |
| NaCl | 173 | 0.97 | 0 | 0 | | 5e−4 |

*Langmuir adsorption isotherm was assumed: q_i = a_i c_i/(1 + b_i c_i), where q_i and c_i are the concentration in the stationary and mobile phase of component i, respectively. Note that the diffusivity coefficient (Db) has a negligible impact on salt elution curves due to small mass transfer effect.

### SMB Process Design and Simulation

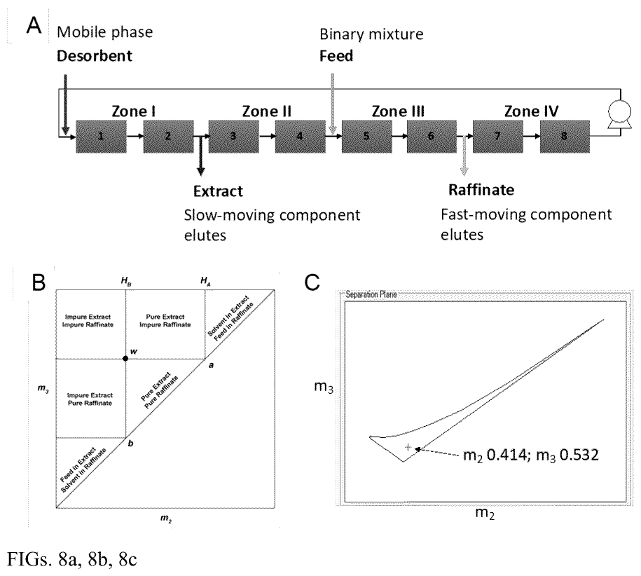

The SMB optimization was conducted based on the 2-2-2-2 configuration, which is a widely used system as shown in FIG. 8A. To obtain, high purity LiCl separation from divalent salts, the operating conditions were found based on the triangle theory (FIG. 8B). In Triangle theory, the dimensionless flowrate ratio, m_i, defined below, is used to calculate the zone flowrate to predict high purity separation regime.

$${m}_{i} = \frac{net flow rate in zone i}{net solid flow rate in zone i}$$

The triangle domain in FIG. 8C represents possible separation conditions for achieving high purity of both LiCl and divalent salts in outlets, respectively. Here, LiCl is eluted out at the raffinate port while divalent salts are eluted out at the extract port. Because the triangle theory approach was based on the ideal system, the peak spreading by mass transfer phenomena is not considered, which limits the conditions near triangle boundaries. For this reason, we found an SMB operating condition for high purity separation from near the center of the triangle region as marked in FIG. 8C and listed in Table 4.

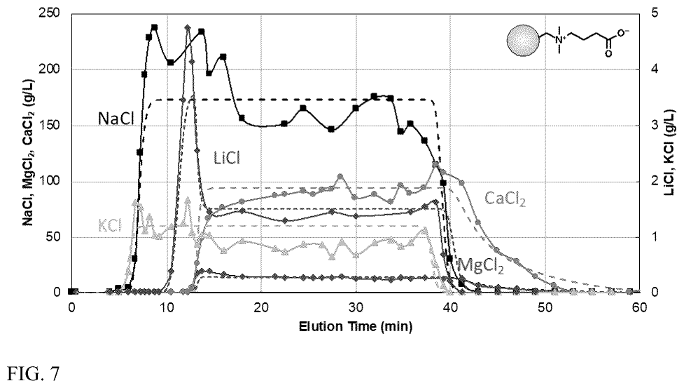

TABLE 4
SMB operating conditions for FIG. 7, corresponding to the
red mark in FIG. 6C.
Zone flowrate

| Zone 1 | Zone 2 | Zone 3 | Zone 4 | Switching |
|---|---|---|---|---|
| (mL/min) | (mL/min) | (mL/min) | (mL/min) | time |
| 2.908 | 1.693 | 1.795 | 1.654 | 10 min |

In/outlet conditions

| Desorbent | Extract | Feed | Raffinate | Recycle |
|---|---|---|---|---|
| (mL/min) | (mL/min) | (mL/min) | (mL/min) | (mL/min) |
| 1.254 | 1.214 | 1.002 | 0.14088 | 1.654 |

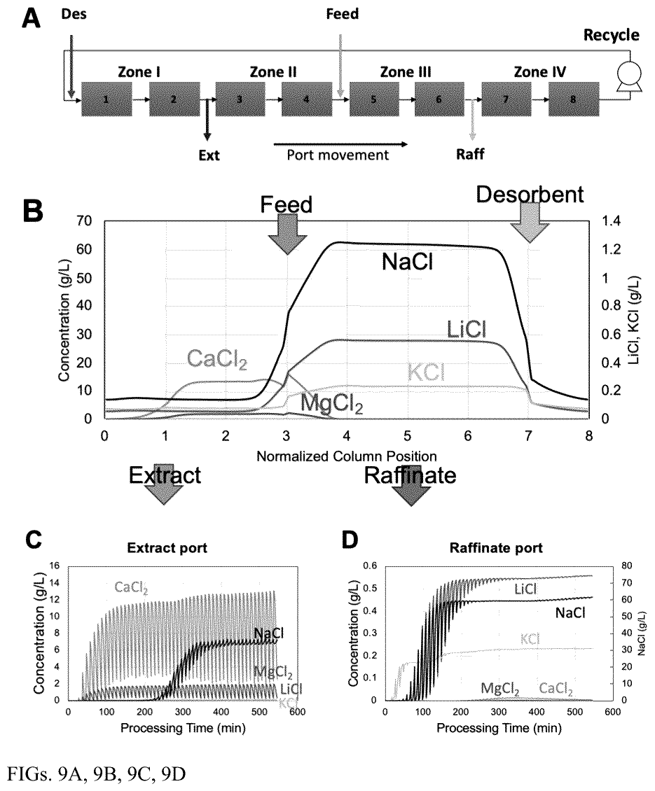

SMB simulation was conducted based on the parameters in Table 3. The 2-2-2-2 zone configuration was used (FIG. 9A) and the effluent profiles were monitored to obtain yield, purity, and productivity data. A cyclic port switching among eight columns allows to load feed and recover purified products continuously. The SMB process reached a steady state after 390 min. The axial profile in FIG. 9B presents the movement of each component in a series of columns. FIG. 9C and 9D show effluent profiles at the extract and raffinate ports, respectively. It was noted that there were bleedings of NaCl and KCl in the extract port but the concentration of LiCl was less than 0.06 g/L, about 4.4% yield loss of LiCl. In the raffinate port, LiCl was recovered at about 0.56 g/L with NaCl and KCl, separated from MgCl2 and CaCl2. The concentration of MgCl2 and CaCl2 at the raffinate port was 0.000022 and 0.0044 g/L in the steady state, respectively. Please note that the desorption curve of LiCl came later than the real data, the desorption curve of LiCl moves faster than that of simulation such that we expect that both purity and yield will be higher in actual demonstrations.

With the determined zone configuration, switching sequence, and operating conditions using the QAC3CA sorbent, the purified LiCl recovery yield and productivity were predicted as 95.6% (or 5.3% based on the definition of throughput yield) and 2.69 g LiCl/L/hr, respectively, and the purity of LiCl against the divalent salts was shown as 99.1%, which met the milestone goal. Further optimization in zone configuration and operation conditions will be conducted to increase the yield and productivity of the SMB process. Additionally, the separation of LiCl from monovalent salts will be conducted to achieve high purity LiCl recovery from Na-enriched streams. This result has a significant impact on mineral separations since we can ultilize this process into separating lithium from high salinity streams, which were not be feasible with the conventional separation processes or nanofiltrations.

Lithium is regarded as a critical mineral due to its use in energy storage systems, electronic vehicles, and rechargeable electronics. Accordingly, the global lithium demand is expected to grow annually by 15˜20% until 2030 from use in green technologies. Currently, lithium is supplied from mineral ores and salar brines, the latter of which make up roughly 48% of Li production worldwide, mostly located in Argentina, Chile, and Bolivia. However, conventional Li extraction processes for these resources raise environmental concerns due to large chemical footprints and inefficient separation processes. For example, in a typical process for lithium extraction from the Salar de Atacama, after solar evaporation to concentrate the lithium, the brine is acidified using hydrochloric or sulfuric acid and then mixed with an organic extractant to remove boron from the solution. The brine is then treated with sodium carbonate and calcium hydroxide to remove magnesium. Finally, the brine is treated again with sodium carbonate at high temperatures to precipitate the lithium as lithium carbonate.

There are other unconventional lithium resources such as geothermal brines, formation water, oil-produced water, and mine tailings that contain significant amounts of Li but are not currently exploited for Li. Unlocking these resources would help meet the increasing Li demand, but they are challenging to recover Li from because the Li concentration typically occurs between 300 to 1,000 ppm in these resources and considerably higher Na+, Ca2+, or Mg2+ concentrations are also present. These other cations can be up to 50 to 100 g/L depending on the source. Therefore, a more energy-efficient, less chemical-intensive, and scalable lithium extraction processes needs to be developed to extract Li from unconventional lithium resources.

To tackle these Li separation challenges in unconventional resources, Direct Lithium Extraction (DLE) processes are widely studied. DLE is based on either adsorption, ion exchange, or solvent extraction. In adsorption based DLE, inorganic hydrous oxides are often applied as a selective ion-sieve type adsorbent. Some of these hydrous oxides include lithium manganese oxide, lithium titanium oxide, and lithium aluminum layered double hydroxide chloride. However, the stability and capacity of these adsorbents need to be improved and specific chemicals are required to desorb Li from the loaded oxide. The ion exchange approach of DLE uses ion exchange resins, which require regeneration with strong acids and therefore have large environmental footprints and high chemical consumption costs. DLE based on solvent extraction uses a selective Li extractant in the liquid organic phase. However, solvent extraction is not efficient because low feed concentrations of Li cause slow mass transfer between the two phases and also it generates large chemical and environmental footprints from the phase separation and stripping processes. Recently, membrane-based or electrochemical-based technologies have reported a high Li selectivity and feasibility of concentrating Li, but implementing the process at a large scale remains an open question.

In this study, we propose a new scalable Li extraction approach, which we call mineral fractionation with ZwitterIonic Chromatography (ZIC). ZIC has been studied and used for separating hydrophilic components in analytical chemistry and is commonly known as hydrophilic interaction chromatography (HILIC). In analytical chemistry, HILIC typically uses organic modifiers such as acetonitrile and methanol in the mobile phase to increase the solutes' partitioning in the stationary phase. It was also reported that ZIC can separate salts with water elution in HPLC systems. Water works as an eluent without the addition of chemical modifiers because the charge neutrality must be maintained in the system resulting in both cations and anions interacting with the ZI stationary phase but eluting as a paired single solute. This is known as the ion-paring effect.

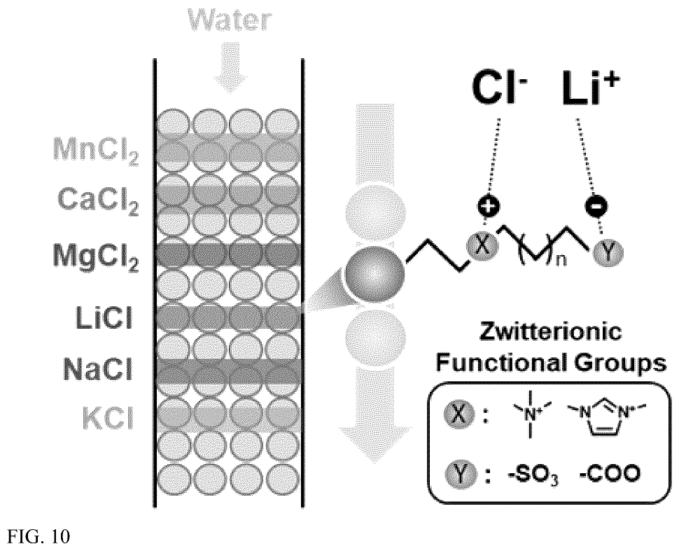

The paired salts are separated with different retention times due to the differences in their ion charges, hydration shell of the of ions, and the structure of ZI functional groups (FIG. 10), others have demonstrated the separation of paired salts with water elution using a silica-based IMC3SA sorbent at the analytical scale, but did not consider LiCl separation from other salts nor explore how different types of ZI functional groups can affect separation. Building on that work, we hypothesized that if an appropriate ZI stationary phase can be developed that has high selectivities of LiCl over other salts in solution, LiCl can be efficiently separated from other salts from unconventional brines without using chemicals and using water alone as the eluent. This ZIC separation approach for LiCl can then be scaled in a continuous liquid chromatography system such as a Simulated Moving Bed (SMB).

Accordingly, the goal of this study is to develop a new ZI sorbent having a high selectivity of Li against other salts for efficient Li fractionation. To accomplish this, we synthesized new ZI sorbents with varying ZI functional groups, pore size, and the carbon chain length between ZI groups from the commercialized polymer resins. The salt elution was tested on various types of ZI groups to find the optimum ZI functional group configuration for efficient Li separation. Mineral fractionation was also demonstrated with a real Li-containing brine on the selected ZI sorbents that have high selectivity of Li over divalent salts. The elution mechanism of salt elution on ZIC was analyzed based on experimental and simulation studies.

### Materials and Equipment

An ÄKTA pure chromatography system manufactured by Cytiva was used to control solvent flowrate and to collect real-time conductivity, UV, and pH measurements. Diba Omnifit EZ glass columns (inner diameter 1 cm and 33 cm or 15 cm length) with adjusters were used to hold resin.

Ultrapure water (UPW) was obtained from a Barnstead™ Easypure™ II water purification system. Polymeric resins, N,N-dimethylaminomethyl polystyrene-divinylbenzene (PSDA) resin with two different pore sizes, and chloromethyl polystyrene-divinylbenzene (PSCM) resin were purchased from NETQEM LLC. Polyethylene Glycol 8000 (PEG8000) was purchased from Research Products International. Dextran T-2000 was purchased from Pharmacia Biotech. Ethanol, lithium chloride (LiCl, ≥99%) potassium chloride (KCl, ≥99%), magnesium chloride (MgCl2, ≥98%), and calcium chloride (CaCl2, >97%) were purchased from Sigma Aldrich. Sodium chloride (NaCl, ACS grade) was purchased from Fisher Chemical.

### ZI Resin Synthesis

Quaternary Ammonium (QA)-based and Imidazole (IM)-based ZI resins were prepared from PSDA and PSCM, as illustrated in FIGS. 2 and 3, respectively.

### Elemental Analysis of C, H, N, and S

Each synthesized resin and the base unfunctionalized resins were analyzed for carbon, hydrogen, nitrogen, and sulfur to determine the degree of functionalization after the synthesis procedure. For this measurement, a LECO CHN 628 series with a Sulfur Add-on Module (S628) (LECO Corporation; St. Joseph, MI) was used. A sample size of 100 mg of ZI resin was prepared for CHN and S, separately. The CHN and S analysis procedures followed previously reported methods.

### Thermogravimetric Analysis (TGA)

TGA experiments were performed using a Discovery Series TGA 5500 (TA Instruments). Here samples of 6 mg were loaded onto platinum pans for analysis. During analysis, the sample was purged with nitrogen gas at a flow rate of 25 mL/min. A high-resolution dynamic method from 50° C.-700° C. was used for analysis. The method consisted of a 20 ° C./min ramp rate when there was no weight loss, and the ramp rate would slow to 4° C./min when weight loss was detected by the software. TA Instruments Trios Software was used to analyze both weight loss and derivative curves.

### BET Analysis

The pore size distribution of PSDA and PSCM was characterized by using N2 physisorption at 77 k with a Quadrasorb evo. Prior to performing the surface area, pore volume, and pore diameter measurements, the samples were dried under helium flow for 24 hours at 200 ° C. The surface area was measured using multipoint BET analysis. The ‘BJH Method’ was used to calculate the pore volume and diameter.

### Column Packing

A slurry packing method was used to pack a column with ZI resins. Each resin was first soaked in UPW and sonicated for 30 minutes to remove any air or impurities from the particle pore phase. The resins were then sieved to remove fines and agglomerates. After sieving, the remaining resin was transferred to a 100 ml beaker and mixed with water to form a 60% (v/v) slurry. Two Omnifit columns were connected using an adapter and the bottom plunger was attached with a plug. The resin slurry was poured into the column until both columns were near full. The top plunger was affixed, and the assembly was allowed to settle for at least an hour before running 2 mL/min of UPW through the assembly to further pack down the resin. After the resin height stabilized, the top column and adapter were removed, and the top plunger was affixed to the top of the bottom column. The column was then connected to AKTA and flushed with UPW at 7 mL/min until the conductivity readings lowered to less than 0.01 mS/cm. After the column was cleaned, the top plunger was adjusted down to fix the column length.

### Porosity Measurement

The bed porosity and total porosity were measured by a pulse test with non-interacting tracers. To determine bed porosity (ε_b), 0.2 wt. % PEG 8000 was used as a tracer for QA-based (small pore) columns and 0.4 wt. % Dextran T2000 was used for IM-based (large pore) columns. A pulse test was performed with a sample injection loop (0.5 mL). Flowrate was varied at 0.7 or 2 mL/min for IM-based or QA-based columns, respectively, to match the convection time closely. UV 190 nm data was used to find the volume at the center of mass (VCM). The bed porosity was calculated using equation (1), below. The total porosity (ε_t) was measured with a pulse test by using D2O as a tracer for QA-based columns. The effluents were collected, and each fraction was analyzed with FT-IR. The absorbance at 2500 cm−1 was used to measure the D2O concentration. For IM-based columns, the total porosity was measured from ethanol frontal tests, wherein a 30 wt. % ethanol solution was loaded into the column that was pre-saturated with ethanol. The center mass of a breakthrough curve (VCM) for ethanol was determined from the trace at UV 190 nm and the total porosity (ε_t) was calculated via equation (2), below. Particle porosity (e_p) was calculated from the bed porosity and total porosity using equation (3), below.

$${ε}_{b} = \frac{{V}_{C M} - {V}_{d}}{B V} \qquad ( 1 )$$

$${ε}_{t} = \frac{{V}_{C M} - {V}_{d}}{BV} \qquad ( 2 )$$

$${e}_{p} = \frac{{ε}_{t} - {ε}_{b}}{1 - {ε}_{b}} \qquad ( 3 )$$

In these equations, V_CM is the center of mass of a peak or breakthrough curve, V_d is the extra-column volume, and BV is the bed volume. Note that half of the feed injection volume (Vinj) was included in Vd for the pulse test

### Salt Elution Test in ZIC

Salt retention on packed ZI columns was measured with a pulse test. To approximate the same convection time through columns of different lengths, the flowrate was fixed at either 0.7 or 2 mL/min for short (6-9 cm) or long (25-29 cm) columns, respectively. A 10 g/L pulse of each salt, LiCl, NaCl, KCl, CaCl2, and MgCl2, was injected from a sample loop (0.5 mL) into each ZI column and eluted with water. The elution profile was monitored with the conductivity signal. After eluting each salt, the column was cleaned by flushing with water until the conductivity returned below 0.1 mS/cm.

For multicomponent separations, pulses of mixed salt solutions were injected and eluted with water. A mixture of 10 g/L NaCl and LiCl (6 mL) was injected into the QAC3CA column and eluted with water. Similarly, a pulse of 5 g/L of the five salts (0.5 mL) was loaded on the IMC3CA column and separated with water elution. The column effluents were collected periodically and analyzed to generate chromatograms.

### FTIR-ATR/FTIR-TGA

Column effluents from D2O pulse tests were analyzed via FTIR on PerkinElmer FT-IR Spectrum 3 in ATR mode. A 10 μL of each effluent was placed on the surface of ATR crystal and the spectra were measured from 450-4000 cm−1 at 2 cm−1 resolutions over 48 scans.

Evolved Gas Analysis (EGA) was conducted by loading 5-7 mg of sample into a tared 90 μL alumina TGA pan. The pan was then placed into a TA Instruments Discovery SDT 650 instrument connected to a PerkinElmer FT-IR Spectrum 3 spectrometer equipped with a TL 8000 Balanced Flow FT-IR EGA System. A PerkinElmer TGA-IR Interface TL 8000e was used to set the temperature of the adapter cell and TL-TGA of the EGA System to 270° C. and control the flow to 70 mL/min. A background spectrum was performed before each sample was run with a resolution of 4 cm−1 and an accumulation set to 64 scans. The sample was then heated under nitrogen (100 mL/min) from ambient temperatures to 700° C. at a ramp rate of 50° C./min. A simultaneous experiment was conducted on Spectrum 3 to analyze the evolved gas from the Discovery SDT 650 using a wavenumber range from 650-4000 cm−1, at a resolution of 4 cm−1, and an accumulation set to 2 scans. The pan was cleaned after each run by running an isometric hold at 700° C. for 10 minutes. All TGA curves were analyzed using TA Instruments Trios software while all FT-IR spectra were analyzed using PerkinElmer Spectrum IR software.

### ICP-OES Analysis

The concentration of the cations in the effluent mixtures was measured via Inductive Coupled Plasma Optical Emission Spectroscopy (ICP-OES). The effluent samples were diluted in 2% nitric acid (Sigma Aldrich, ICP grade) with appropriate dilutions and then 10 mL of each sample was loaded into an Agilent 5100 ICP-OES. The operation conditions are as follows: RF power of 1.40 kW; read time of 20 seconds; stabilization time of 15 seconds; nebulizer flow of 0.60 liters per minute; plasma flow of 13 liters per minute; auxiliary flow of 1 liter per minute. Sodium was analyzed at 589.592 nm; calcium at 315.887 nm; lithium at 610.365 nm; and magnesium at 285.213 nm. These wavelengths were viewed in axial mode at a height of 8 mm. Yttrium was used as an internal standard for this analysis.

### HPLC Analysis

To quantify the salts in the effluents, an HPLC-Charged Aerosol Detector (CAD) system was employed.[27,28] The CAD detector (Dionex Esa Corona Charged Aerosol Detector) was connected to Agilent HPLC 1200 system via a G1930B Universal Interface Box. The CAD signal was monitored with Agilent OpenLab CDS v5. The column used was a SeQuant ZIC-zHILIC 5 μm PEEK coated 4.6 mm×100 mm column with a ZIC-HILIC guard column. The mobile Phase A consisted of a mixture of 100 mM ammonium acetate in water (pH 4.7), acetonitrile, Isopropyl alcohol, and methanol (150/650/200/50 mL). The mobile Phase B consisted of a mixture of 30 mM ammonium acetate in water (pH 4.7), acetonitrile, isopropyl alcohol, and methanol (500/250/200/50 mL). The flow rate was set to 0.5 mL/min. A gradient elution was used (T:0 45% B, T:15 65% B: T:17 65% B) with a re-equilibration time of 8 min. The column temperature was set to 30° C. The injection volume was 2 μL. A calibration curve was prepared with 6 points, 25 ppm, 50 ppm, 100 ppm, 250 ppm, 1000 ppm, and 2500 ppm. Due to the nature of the CAD detector, a quadratic calibration was used.

### Resin Synthesis

To investigate the effect of ZI functional groups on salt elution, we synthesized resins with various acidic and basic functional groups and also varied the carbon chain length between two charged functional groups to find an optimal ZI configuration to have high selectivities between LiCl and other salts. For negatively charged basic groups, the non-dispersed and dispersed groups were compared by employing quaternary ammonium (QA) and imidazolium (IM) groups, respectively. For positively charged acidic groups, strong and weak acid functional groups were compared by including sulfonic acid and carboxylic acid groups, respectively.

The chemically bonded quaternary ammonium (QA) and imidazolium (IM) based ZI stationary phases were prepared based on the synthesis routes described in FIGS. 2 and 3, respectively. The QA-based resins were prepared from the commercially available weak base resins, PSDA. The IM-based resins were prepared from PSCM after converting to imidazolium-functionalized resins, PSIM, as shown in FIG. 3. For both resins, the sulfonic (SA) or carboxylic acid (CA) groups were attached to the starting resins by varying carbon chain lengths.

### Resin Characterization

The pore size distribution of the starting materials PSDA and PSCM was measured via BET analysis. PSDA was prepared with two different pore sizes. The small pore PSDA showed that the pore size is mostly varied from 5 to 10 nm whereas the large pore PSDA has a widely distributed pore size from 5 to 36 nm. It should be noted that all the QA-based resins in this study were prepared with the small pore one unless otherwise mentioned. PSCM was prepared with large pores distributing from 5 to 50 nm because it was required to have a sufficiently large pore size to allow bulky imidazolium groups and precursors to enter the pore phase.

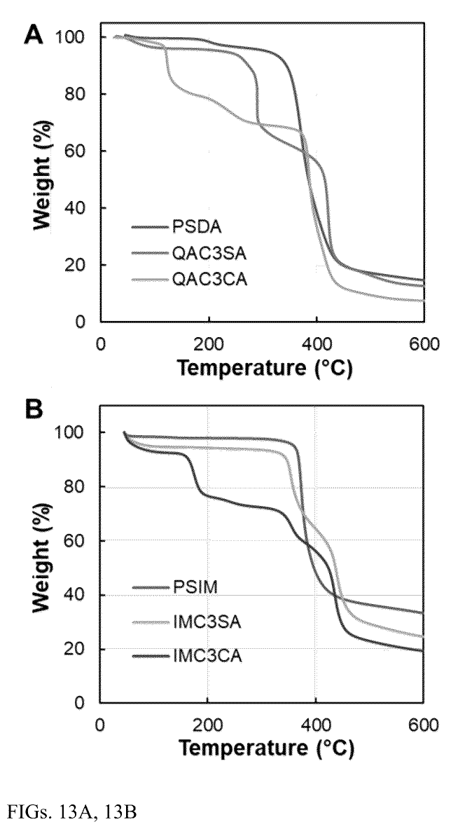

TGA analysis was conducted for the prepared resins to confirm the existence of ZI groups. The TGA curves and TGA-FTIR data of the prepared ZI resins are shown in FIG. 13. In FIG. 13A, the curve of the starting material (PSDA) shows a 3.2% weight loss between 150 ° C. and 250° C., indicating the amine groups and a steep weight loss at around 400° C. shows the decomposition of polymer backbones. For QAC3SA, there is an additional weight loss between 200° C. and 350° C. due to the sulfobetaine groups. This was supported by the FTIR-TGA spectrum of strong N—H and S═O stretching at 2776-2958 cm−1 and 1342-1376 cm−1, respectively. Carboxybetaine groups showed two distinct weight losses. FTIR-TGA of QAC3CA showed the first weight loss occurred between 100° C. and 170° C. where the strong peaks at 1042, 1158, and 1820 cm−1 indicate that carboxylic groups are decomposed first. The second weight loss between 200° C. and 350° C. was due to amine group decomposition, similar to QAC3SA. In FIG. 4B, the PSIM base resin showed only one weight loss at around 400° C. which was imidazole and styrene compounds. For IMC3CA, the first decomposition between 100° C. and 200° C. showed almost the same FTIR spectrum as QAC3CA, meaning that carboxylic acid was decomposed. The second weight loss observed between 300° C. and 400° C. was due to the decomposition of imidazole groups. For IMC3SA, since both imidazole and sulfur groups were decomposed between 300° C. and 400° C., it was difficult to identify two different functional groups from the TGA curves (FIG. 9B).

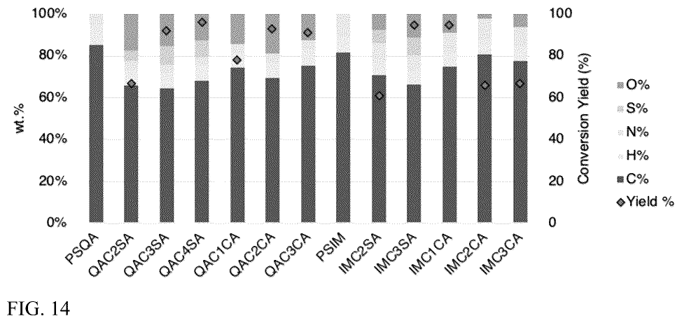

Additionally, the C, H, N, and S elemental analysis was conducted for each resin. The mass difference was regarded as oxygen content. The compositional analysis of the ZI resins was summarized in FIG. 14. Here, the N, S, and O contents represent the existence of ZI functional groups. Based on the elemental analysis, the synthesis yield was calculated for each chemistry using Equation (4), below. The synthesis yields of ZW resins were varied with different carbon chain lengths and functional groups. We associate these differing functionalization yields to the reactivity differences of the ZI precursors.

$$Synthesis yield = \frac{actual mass ratio of O / N or S / N}{ideal mass ratio of O / N or S / N} * 100 ( \% ) \qquad ( 4 )$$

TABLE 5
Column size and porosities for the prepared ZI columns:

| | | Column | Bed | Total | Intraparticle |
|---|---|---|---|---|---|
| | | length | porosity | porosity | porosity |
| No. | Column name | (cm) | (ε_{b}) | (εₜ) | (εₚ) |
| 1 | QAC2SA | 29.0 | 0.36 | 0.57 | 0.33 |
| 2 | QAC3SA | 24.8 | 0.36 | 0.70 | 0.53 |
| 3 | QAC4SA | 28.4 | 0.39 | 0.60 | 0.34 |
| 4 | QACICA | 28.9 | 0.37 | 0.61 | 0.38 |
| 5 | QAC2CA | 28.0 | 0.36 | 0.57 | 0.33 |
| 6 | QAC3CA | 28.6 | 0.37 | 0.63 | 0.41 |
| 7 | IMC1CA | 6.5 | 0.34 | 0.70 | 0.55 |
| 8 | IMC2CA | 9.3 | 0.32 | 0.73 | 0.60 |
| 9 | IMC3CA | 8.6 | 0.35 | 0.77 | 0.65 |
| 10 | IMC2SA | 9.4 | 0.34 | 0.74 | 0.61 |
| 11 | IMC3SA | 8.1 | 0.36 | 0.75 | 0.61 |
| 12 | QAC3SA (large | 11.1 | 0.36 | 0.68 | 0.50 |
| | pore 95 Å) | | | | |
| 13 | QAC3CA (large | 7.6 | 0.36 | 0.70 | 0.53 |
| | pore 95 Å) | | | | |

### ZI Column Porosity Measurement

The prepared resins were packed in a column for dynamic loading tests. The well-packed columns were first characterized with pulse tests using a tracer to determine the bed porosity and total porosity. Since most widely used tracers can interact with ZI groups, the selection of tracers was important. It was found that PEG8000 and Dextran T2000 do not interact with the ZI stationary phase and are fully size-excluded from both the QA-based and IM-based resins. Thus, the bed porosities for QA-based and IM-based columns were measured with PEG8000 and Dextran T2000. For the total porosity measurement, D2O and ethanol were used as non-retained small tracers for QA-based and IM-based columns. For instance, the QAC3CA column shows that the bed porosity and the total porosity were measured as 0.37 and 0.61, respectively, from the pulse tests. Using these values, the intraparticle porosity was calculated as 0.38 from Eq. (1). The packed column size, its bed, intraparticle, and total porosities of all ZI columns are summarized in Table 5.

### Effect of ZI Functional Groups on Salt Retention Profiles During Water Elution

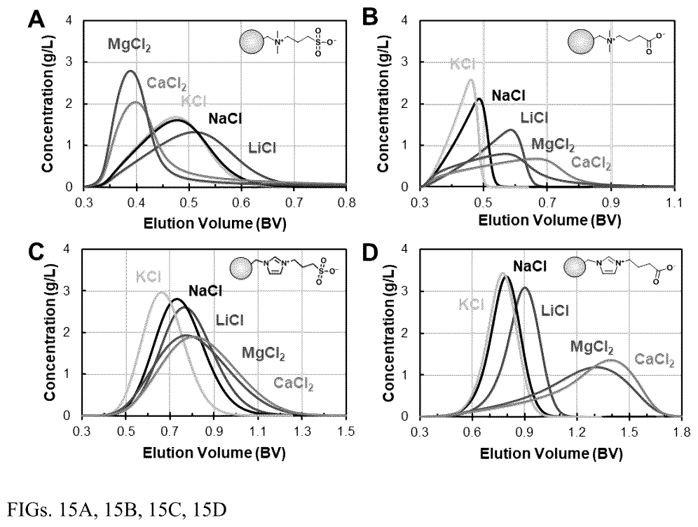

FIG. 15 shows that the salt elution behaviors were significantly affected by different functional groups. Each salt was eluted with water by the ‘ion-pairing’ effect and thus, salts were partitioned with different retention times. This result is consistent with the prior literature that used small HPLC columns. The elution order was from monovalent to divalent salts, starting from KCl, NaCl, LiCl, MgCl2, and CaCl2, in all cases except QAC3SA. Divalent salts, CaCl2 and MgCl2, were mostly overlapped among all ZI columns with low selectivity. Most peak fronts began at the same position due to weak interaction with ZI stationary phase.

Interestingly, QAC3SA exhibited a reversed elution order compared to the others (FIG. 15A). In the reported HILIC system, it has been known that the elution order starts from monovalent to divalent salts because of divalent salts' higher affinity to the ZI stationary phase compared to the monovalent salts. However, in this case, MgCl2, and CaCl2 eluted earlier than monovalent salts, indicating the size exclusion of divalent salts from the resin pores. The spreading of monovalent salt peaks also indicated a partial size exclusion from the resin pores. As a result, LiCl was retained longer than other salts due to its small size. This was consistent with a previous report from Lounder et. al. that demonstrated the size exclusion of divalent salts from a membrane functionalized with the same QAC3SA group with a pore size of less than 1 nm.

FIG. 15B shows the salt retention on QAC3CA functionalized resin. Although it has almost the same pore size as QAC3SA, there was no size exclusion of divalent salts. Instead, the divalent salts were spread and had long tailings, indicating higher sorbent affinities than monovalent salts. In this system it is clear that monovalent salts exhibit unusual fronting and sharp ends to their elution peak shapes. This non-gaussian peak shape suggests that the penetration of salt into the pores is thermodynamically unfavorable but the desorption from the ZI stationary phase is thermodynamically favorable, which is similar to a multilayer or anti-Langmuir isotherm mechanism. In this system, the longer retention of LiCl compared to other monovalent salts showed a possibility of separating LiCl from NaCl and KCl with water elution.

In FIG. 15C, the salt elution test on IMC3SA showed that there was no size exclusion of divalent salts from the pores as compared with QAC3SA. Rather, the elution order was the same as QAC3CA or IMC3CA as a result of the large pore size and different basic group compared to QAC3SA. Thus, no significant selectivities of LiCl to other salts were observed. This indicates that a combination of strong acid and dispersed basic groups in the IMC3SA resin has the weakest interaction between salts and the ZI stationary phase.

FIG. 15D shows the salt retention significantly varied depending on the species in IMC3CA. The elution order was from KCl to CaCl₂, which was the same as QAC3CA or IMC3SA. However, the overall salt retention was longer than the other stationary phases. Especially, the divalent salts which were eluted longer than LiCl with a long fronting peak shape, suggesting that LiCl can be separated from CaCl2 and MgCl2 with a high selectivity. These elution results suggest that a combination of the imidazole and carboxylic acid groups had the strongest interaction with salts in the mobile phase.

In an embodiment, a control experiment using PSDA, the non-functionalized resin, as the stationary phase was ran and there was no separation of the salts.

### Effect of Pore Size on the Salt Elution in ZIC

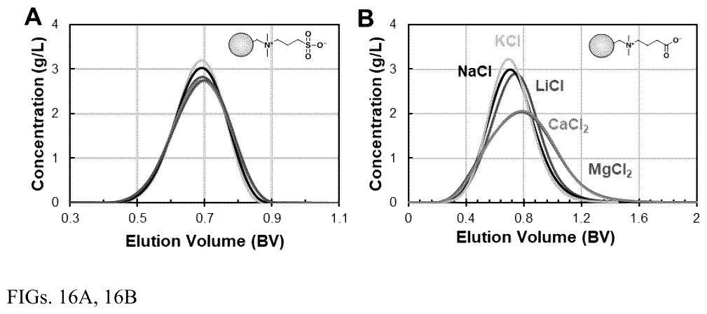

Pore size control is an important factor to increase the salt partitioning on ZI stationary phases. To compare the effect of the pore size on the salt retention behavior, we prepared QAC3SA and QAC3CA resins with larger pore sizes than the one used in FIG. 15. As shown in FIG. 16, the salt elution on both large pore QAC3SA and QAC3CA showed typical Gaussian curves at similar retention times, which were significantly different from results shown in small pore ones. Clearly, there was no size exclusion for divalent salts on the large pore QAC3SA (FIG. 16A), compared to FIG. 15A. This means that the size exclusion of divalent salts was shown only in QAC3SA with the small pore resin. We attribute this to the high surface density of QAC3SA functional groups within the small pores assisting in the rejection of strongly hydrated ions such as Ca2+ and Mg2+. Similarly, there were several peak overlaps among salts in the large pore QAC3CA in FIG. 16B, showing the low selectivity of LiCl to monovalent salts compared to that of the small pore one (FIG. 15B). Also, the monovalent salt peaks had no sharp tails indicating that there was little effect from the hydration reaction on the retention of monovalent salts in the large pore stationary phase. Overall, these results exhibit that both pore size and functional groups synergistically affect the salt retention on the ZIC.

### Effect of Carbon Chain Length on the Salt Elution in ZIC

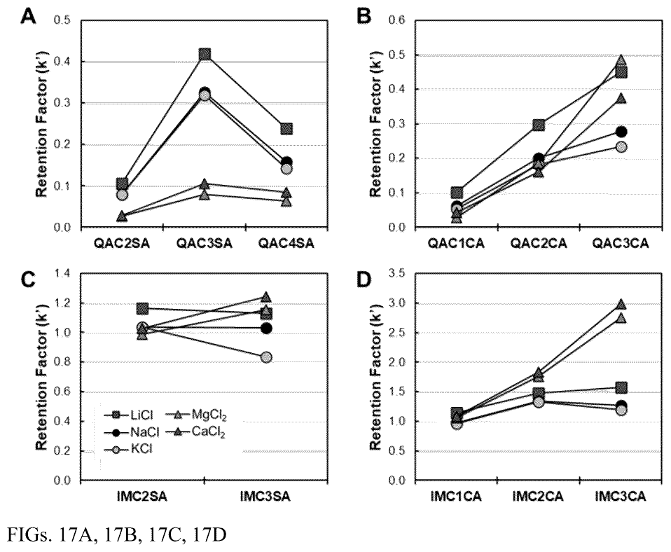

The effect of the carbon chain length between ZI groups on salt retention was investigated for each ZI group. In an embodiment, the same pore size was used for all resins to realize the size exclusion effect from the resin pores as described above. FIG. 17 summarizes this data by reporting the retention factor (k′) for the major salts that occur in brine samples. The retention factor (k′) was calculated from the pulse test of each salt on each ZI column and was measured from the maximum peak height. Although the retention plot does not directly relate to the separation efficiency due to the long fronting or tailing as seen in FIG. 15, it is sufficient to show trends in salt separation as a result of the carbon spacing between ZI groups.

FIG. 17A shows the obvious size exclusion effect on the peak of all cations. LiCl forms a weak hydration shell and thus the apparent radius of ions is much smaller than others. This results in the weakest size exclusion effect for LiCl compared to the other salts. Interestingly, the QAC3SA resin showed the most effective size exclusion effect.

FIG. 17B shows the increase in k′ for all salts as the carbon chain length increases between the charged groups, leading to increasing resolution between LiCl and NaCl. This suggests that QAC3CA is the most efficient resin to separate LiCl from other monovalent cations, which is a needed operation for the Li refining process.

IM-SA resins showed weak hydrophilic interactions with the stationary phase, leading to low selectivities among LiCl and divalent species (FIG. 8C). For IM-CA resins in FIG. 8D, there were significant retention differences between divalent species and LiCl as the carbon chain length increases, resulting in high selectivities of LiCl to divalent salts in IMC3CA. In summary, the results showed that the three carbon chains between the ZI group is a generally optimal configurations to have high separation efficiency.

### Multicomponent Separations on ZI Stationary Phase

For a multicomponent separation, we further investigated QAC3CA and IMC3CA since they were considered as promising sorbents to separate LiCl from other major salts in brines. The reason was that QAC3CA has the advantage of separating LiCl from monovalent species due to the unique sieving effects while IMC3CA has high selectivities between LiCl and divalent species as LiCl elutes faster than CaCl2 or MgCl2.

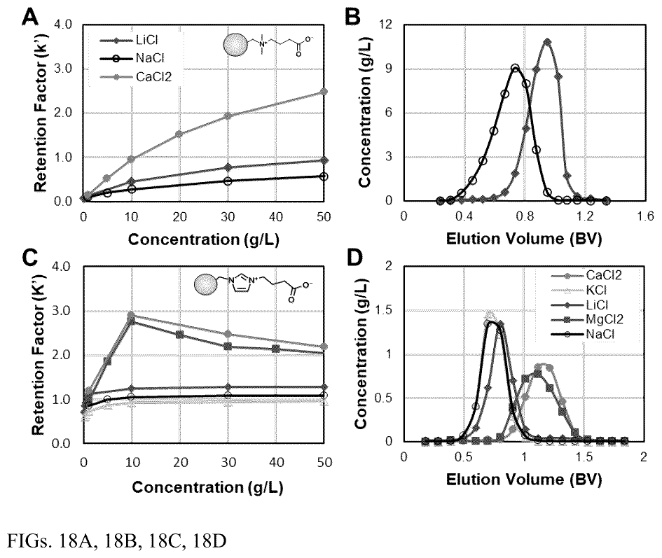

FIG. 9A shows the retention factor (k′) of NaCl, LiCl, and CaCl2 on QAC3CA with increasing concentrations of salts in the input pulse. The retention time at the maximum peak height was measured to calculate k′. In FIG. 18A, k′ increases as the concentration of the salt in the input pulse increases in all cases, indicating that a linear isotherm is not followed in this system. The elution profiles of monovalent salt were consistent with increasing concentrations, however, the elution profiles of CaCl2 showed that CaCl2 is more strongly retained as the concentration increases.

Since there was a noticeable retention difference between NaCl and LiCl, a separation of LiCl from NaCl was conducted. FIG. 18B shows a partial separation of LiCl from NaCl under water elution. Compared with elution profiles in FIG. 15B, the peak tail of NaCl was not sharp but the peak profile of LiCl was still close to the one from a single pulse test. As a result, LiCl can be partially separated from NaCl, yielding nearly 15% recovery with 99% purity by loading 27% BV of a binary mixture.

Salt retention on IMC3CA was also measured with increasing concentrations of salts in the input pulse (FIG. 18C). It was noted that the k′ of monovalent salt species had slightly changed at the low concentration range (<5 g/L) but showed almost constant values at higher concentrations. While the divalent species showed the maximum k′ achieved at around 10 g/L but then the peaks at the higher concentrations eluted faster as the concentration increased, similar to an overloading elution profile. Accordingly, there is an optimal input concentration band where the partitioning effect of ZI groups on divalent salts is best realized.

FIG. 18D shows a multicomponent salt separation on IMC3CA under water elution. The elution order of salt was consistent with that of the single pulse test (FIG. 17D) and thus the LiCl peak was mostly separated from divalent species. Considering the molar ratio of LiCl to MgCl2 and CaCl₂, the optimum elution cut will be at 0.8 BV to achieve about 68% yield of LiCl while a total 2.3% yield of MgCl2 and CaCl2 (Figure S12).

### Real Brine Loading Test on IMC3CA

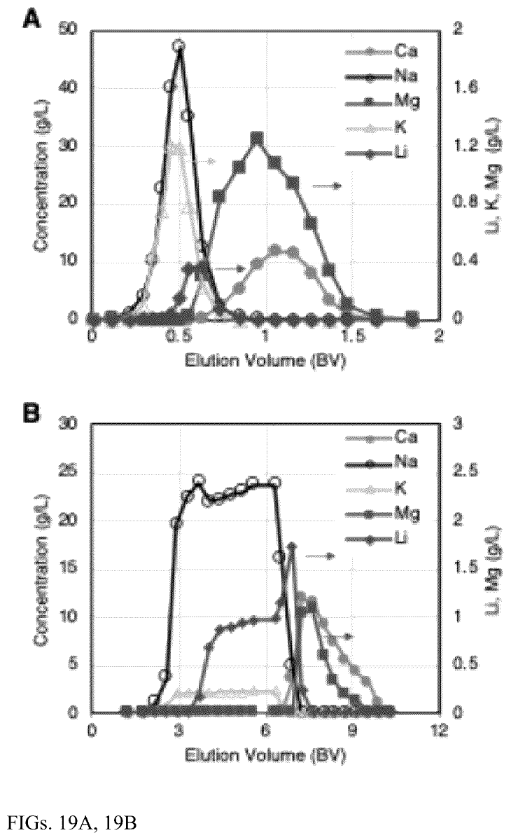

FIG. 19 shows the chromatogram of a real brine solution containing 1.5 g/L LiCl. Since the concentration of each salt varied up to ˜2 orders of magnitude, different scales were used for lower concentration salts. The elution behavior of each salt from the real sample was consistent with the mock solution (FIG. 18A-D) results where the monovalent salts elute faster than divalent salts because of the weaker interaction with the ZI stationary phase. Since the LiCl concentration was much lower than MgCl2 and CaCl₂, the recovery yield of LiCl (21%) was significantly lower than the mock solution test. Thus, the column size and feed loading conditions need to be further optimized to achieve a high recovery yield. Nevertheless, a partial separation of LiCl from divalent salts is promising for scaling up this system in an SMB process.

### Elution Mechanism of Salt on ZIC Under Water Elution

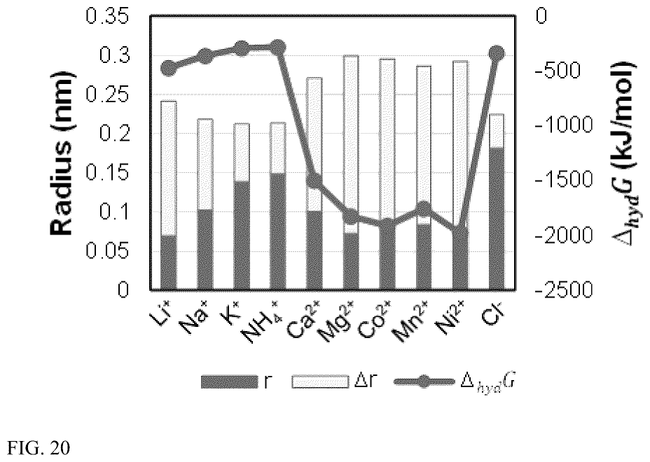

Size exclusion of salts was only observed in QAC3SA resin system. This was attributed to the synergistic effect of the functional group and the pore size of the base resin that results in the dense functional groups on the pore surface. Since the hydrated ions interact with the ZI stationary phase, the degree of hydration and the hydrated ion size affect the size exclusion of ions in these pores. FIG. 20 shows the overall hydrated ion radius and the molar Gibbs free energy of hydration (Δ_hyd G) of the ions in solution. If Δ_hyd G is slightly negative, the ion is easily hydrated. Thus, monovalent cations form weak hydration shells due to high Δ_hyd G. On the contrary, divalent cations form stronger hydration shells with more negative Δ_hyd G and therefore have a bigger size than the weakly hydrated monovalent cations in the mobile phase. This results in divalent salts being almost fully size-excluded and eluted faster than monovalent salts.

The elution order of monovalent salt was from KCl, NaCl, and LiCl, which follows the decreasing order of ionic size and Δ_hyd G. This suggests that monovalent ions are less likely to be hydrated in the pore phase so that LiCl having the smallest ionic radius can be retained longer than NaCl and KCl. However, it was noted that the size exclusion effect of salts on QAC3SA disappeared when loading over 10% BV. We hypothesize that when the mobile phase is saturated with salt ions, the salt screening at the surface of the pore phase is significantly reduced, resulting in salts easily penetrating into the pore phase.

Peak fronting and sharp tailing of monovalent salts were only observed on the small pore QAC3CA. This kind of peak shape has been observed in the HILIC system in the literature, however, there have been no explanations about the mechanism. This unusual peak shape could be theoretically possible in two cases: first, when the process follows either a multilayer or an anti-Langmuir isotherm model [30] or if the mass transfer in the column is significantly affected by the reaction in the mobile phase. [33] Since we could not find evidence of anti-Langmuir isotherm of any salts, the hydration reaction of salt in the water appeared more realistic in this case. Accordingly we explored a more rigorous model of the latter.

To qualitatively understand the effect of hydration reaction on the mass transfer in ZIC, simulation studies were conducted including a reversible hydration reaction as shown below.

$$MCl + {n H}_{2} O ⇄ MCl \cdot {n H}_{2} O \qquad ( 4 )$$

where MCl is an injected salt and MCl·nH_2 O is a hydrated salt species. The terms, k_+ and k_−, denote the hydration (forward) and dehydration (backward) reaction rates, respectively. Further, two dimensionless groups, N_(k+) and N_(k−), were defined to compare the forward and backward reaction rates with the convection rates, respectively.[34]

$${N}_{k +} = \frac{{k}_{+} {L}_{c}}{{u}_{0}} , {N}_{k -} = \frac{{k}_{-} {L}_{c}}{{u}_{0}} \qquad ( 5 )$$

In equation (5), L_c is the column length, u_0 is the linear velocity and the convection rate was defined as L_c/u_0.

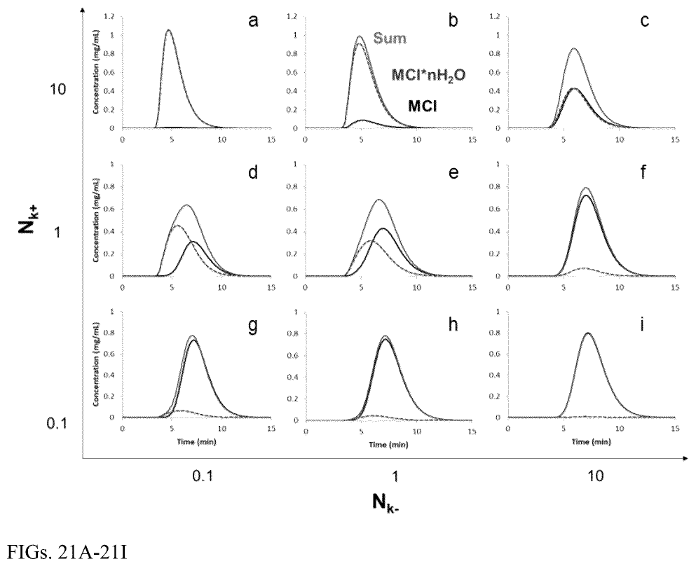

In FIG. 21, the results of the above simulation is shown with the overall concentration profile displayed as the sum of two species, hydrated and dehydrated salt, which is close to what we can observe experimentally. The peak fronting shape structure is noticeable and similar to that of the experimentally observed monovalent salt profile (FIG. 15A) on QAC3CA when both N_(k+) and N_(k−) are unity (FIG. 21E, middle panel). This indicates that the hydration and dehydration reaction rates of monovalent salts are equal and fast enough to be equal to the convection rate. It was also noted that the peak shape of MgCl2 and CaCl2 is similar to the case when N_(k+) and N_(k−) are 1 and 0.1, respectively (FIG. 21D). This means that the hydration reaction is faster than dehydration and thus, there is a retention difference between the strongly hydrated and dehydrated species.

Another noticeable observation was the pH swing at the sharp peak end of monovalent salts. It was assumed that the hydroxide ions generated during the intermediate hydration reactions in the local ZI sites accelerated the salts' ion-pairing in the mobile phase and displaced the paired salts to a re-activated ZI stationary phase, resulting in a sharp peak end followed by pH swing.

### DFT Simulation to Understand Salt Interactions With the ZI Stationary Phase

We investigated how pore size and ZI functional groups affect the salt retention synergistically using molecular simulation studies.

The pore channel was simply designed based on the assumption that ZI groups are fully covered in the pore phase and salt can be transported from the bulk to the pore phase.

The concentration of ions in the pore channel was measured to monitor the salt retention in the pore phase, which is indicative of the pore diffusion and size exclusion of ions during the elution.

QAC3SA had significantly reduced salt retention in the pore phase when the pore size is reduced to 2 nm from 5 nm. This is consistent with our observation from experiments (FIG. 15A and 16A.).

The QAC3CA also shows interesting results by varying pore size. As the pore size decreases, the monovalent salt retentions are varied. The retention of Li⁺ is higher in the pore phase than Na+ and K+. This indicates a longer retention of Li than other monovalent salts, consisting with experimental observations. The retention of Mg ions in the pore phase were reduced in the 20 A pore size and the retention of Ca ions were lower than Li in the pore phase, indicating that intraparticle diffusion of both ions is slower than that of Li. A long tailing from the pulse test in FIG. 15B supports these calculations. However, since Mg and Ca have stronger affinity to the ZI stationary phase, their retention time in the elution took longer than that of monovalent salts in actual system.

### Outlook for ZIC Approach for DLE Process

The ZIC does not fall into the current DLE category, ion exchange, or adsorption, but rather it proposes a new mineral fractionation approach because it uses no chemicals in the eluent. Table 6 illustrates a comparison of ZIC with DLE methods. DLE methods have been developed for efficient Li recovery but often require an equivalent amount of acid or chemicals to separate Li. However, the advantages of ZIC are not only the use of water that is recyclable for mineral fractionation but also the scalability as a continuous process with SMB, which is already widely used at the industrial scale. Therefore, future work will be conducted to develop an SMB process with promising ZI resins that have a high selectivity of LiCl to other salts and investigate the lifetime of ZI resins under a high salinity environment.

By using ZIC, conventional separation processes can be employed to explore unconventional lithium resources, which otherwise were inapplicable due to the high salinity and scaling issues. Assuming that LiCl is expected to be efficiently separated from other salts in brines, the ZIC process will have fewer chemical footprints than conventional hydrometallurgy or other DLE processes. The Li-rich fraction can be concentrated to precipitate Li as salts and to recycle water. This can be performed with Multi-Effect distillation (MED), MED and Mechanical Vapor Recompression (MED-MVR), Closed Circuit RO (CC-RO), or newly developed evaporation systems depending on the brine composition.

TABLE 6
Comparison of DLE technologies

| Classification | | Description |
|---|---|---|
| Conventional | | Solvent evaporation and sequential |
| Hydrometallurgy | | precipitation to isolate Li salts |
| | | Requiring a long evaporation time and |
| | | large amounts of precipitation agents |
| DLE | Adsorption/ | Selective Li binding to the stationary phase |
| | Ion exchange | (adsorption sites or ion exchange resins) |
| | | Desorbing Li with specific eluent, typically |
| | | adjusting pH with strong acid or base |
| | Solvent | Extractants in the organic phase chelate |
| | extraction | with Li to extract from the aqueous phase |
| | | Stripping agents are required to recover |
| | | Li from the organic phase and to |
| | | recycle the extractants |
| | ZIC | Fractionating minerals in brines via the |
| | (disclosed | different partitioning of hydrated salts |
| | herein) | on the zwitterionic stationary phase |
| | | Eluting salts with water and no need |
| | | of regeneration with chemicals |

In this study, we report a new DLE approach, mineral fractionation using the ZIC process. To develop an efficient Li separation, we designed new ZI stationary phases and tested the salt elution on ZIC. The 13 different ZI resins were prepared from commercially available resins. Salt elution tests on each ZI column showed that salt retention under water elution was significantly affected by the pore size, ZI functional groups, and the distance between ZI groups. Small pore size (less than 10 Å) and ZI functional groups have a synergistic effect on the salt elution profiles because of high surface density or ZI groups at the pore phase. For instance, QAC3SA showed a size exclusion of divalent salts and QAC3CA showed a unique elution profile for monovalent salts and high selectivity between LiCl and NaCl. Both QAC3CA and IMC3CA were selected as promising ZI groups for separating Li from brines because of high Li selectivity over Na, or Mg and Ca, respectively. QAC3CA showed an efficient separation of LiCl from NaCl yielding a 45% recovery of 99% purity of LiCl with water elution. Multicomponent separations on IMC3CA showed a Li separation from divalent salts (81% yield at a Li/(Mg+Ca) molar ratio of 27). Simulation studies qualitatively show that the salt elution mechanism on ZIC is related to the hydration reactions of ions in the mobile phase. However, a ZIC model needs to be developed for further detailed analysis.

For extracting Li from the unconventional Li resources, contingent future work will be a development of a continuous ZIC process as an SMB. A successful continuous ZIC operation will isolate Li-rich fraction from brines to achieve a high (>95%) recovery yield but also deploy the commercially available desalination processes for post-concentration and water recovery steps.

Table 7 depicts the chemical composition of brines separated using methods and resins disclosed herein, see FIGS. 19A and 19B.

TABLE 7

| | Smackover brine | Brackish water |
|---|---|---|
| Element | (FIG. 19A) | (FIG. 19B) |
| Lithium (Li) (mg/L) | 212 | 770 |
| Sodium (Na) (mg/L) | 64,978 | 19,260 |
| Calcium (Ca) (mg/L) | 32,941 | 5,447 |
| Magnesium (Mg) (mg/L) | 2,987 | 280 |
| Potassium (K) (mg/L) | 2,417 | 2,050 |
| Strontium (Sr) (mg/L) | 1,837* | 115 |
| Boron (B) (mg/L) | 173 | 7.5 |
| Silicon (Si) (mg/L) | 4* | <1 |
| Chloride (Cl) (mg/L) | 181,000 | 49,500 |
| Bromide (Br) (mg/L) | 429 | 241 |
| Sulfate (SO₄) (mg/L) | 290 | 441 |
| Conductivity (mS/cm) | 222.2 | 40.49 |
| pH | 5.89 | 6.70 |

### ZI Resin Preparation and Characterization

N, N-Dimethylaminomethyl Polystyrene-Divinylbenzene (4.0 mmol/g capacity, 2% cross-linking and particle size 200-400 mesh) (PSDA) and Chloromethyl Polystyrene-Divinylbenzene (3.83 mmol/g capacity, 2-8% cross-linking, 70-100 A pore size, 200 mesh) (PSCM) were used as ZI resin precursors. The large pore PSDA (3.5 mmol/g capacity, 8% cross-linking and particle size 120-200 mesh) was used to investigate the effect of different pore size on the salt retention. The functional groups of PSDA and PSCM were modified to synthesize the ZI resins illustrated in FIG. 2. The intermediate precursors, lithium 3-bromopropionic acid and potassium imidazole were prepared to synthesize ZI resins. All the listed chemicals were ACS grade.

### Lithium 3-Bromopropionic Acid

To a solution of LiOH (2.39 g, 100 mmol) in 80% methanol (180 ml) was added 3-bromopropionic acid (15.93 g, 100 mmol) at around 0° C. After being stirred for 1 hour, the resulting mixture was concentrated via rotary evaporation (bath temperature 30° C.; 5-10 torr) and dried at 60° C. under vacuum (0.1 torr) for 8 hours to yield the title compound in near quantitative yield.

### Potassium Imidazole

Imidazole (22.64 g, 300 mmol) was added to a stirred solution of KOH (300 mmol) in methanol 250 ml). The solvent was removed via rotary evaporation and the resulting salt was dried at 75° C. under vacuum (0.1 torr) overnight to yield potassium imidazole with near quantitative yield (36.20 g).

### PSQAC2SA

A mixture of PSDA (7.60 g, 30.5 mmol), sodium 2-bromoethanesulfonate (8.44 g, 40 mmol), a catalytic amount of KI (1%), and N-Methyl-2-pyrrolidone (NMP) (45 ml) was stirred at 85-90° C. overnight. After the reaction mixture was cooled to room temperature, the solid material was filtered off, washed with water (3×30 ml), methanol (2×20 ml), and dried under vacuum (0.1 torr), at 65° C. for 8 hours to yield 9.81 g (66%) of the title resin.

### PSQAC3SA

The mixture of PSDA (10.0 g, 40 mmol) in dry acetonitrile (CH3CN) (15 ml) and dry tetrahydrofuran (THF) (15 ml) was added to 1,3-propane sultone (5.13 g, 42 mmol) and the reaction mixture was stirred at 75° C. for 10 hours. After the reaction mixture was cooled to room temperature, the solid material was isolated by filtration, and washed with ethyl acetate (AcOEt) (3×20 ml). The resin was initially dried under a flow of nitrogen and subsequently under vacuum (0.1 torr, 60° C.) for5 hours to yield 15.05 g of the titled resin.

### PSQAC4SA

A mixture of PSDA (10.0 g, 40 mmol) in dry CH3CN (15 ml) and dry THF (15 ml) was added to 1,4-butane sultone (5.78 g, 42 mmol) then the reaction mixture was stirred at 80° C. for 10 hours. After the reaction mixture was cooled to room temperature, the solid material was isolated by filtration, and washed with AcOEt (3×20 ml). The resin was initially dry under a flow of nitrogen and subsequently under vacuum (0.1 torr, 60° C.) for 5 hours to yield 15.4 g (99%) of the titled resin.

### PSQAC1CA

A mixture of PSDA (15.00 g, 60 mmol), t-butyl bromoacetate (12.87 g, 66 mmol), and DMF (45ml) was stirred at 75° C. for 8 hours. The resin was filtered off, washed with methanol (3× ml), and dried under a flow of nitrogen. Subsequently, the resin was stirred vigorously at room temperature in a mixture of dioxane (20 ml) and 10 N HCl (12 ml) for 6-10 hours to hydrolyze the ester group. The resin was isolated by filtration, washed with water (3×20ml), and methanol (2×20ml), and dried initially for 30 minutes on a filtration funnel under a gentle vacuum. The obtained material was then stirred with a solution of 10% K2CO3 (150 ml) for 30 minutes before it was isolated by filtration and washed with water (3×50ml) and methanol (2×50 ml). The final product was initially dried under a flow of nitrogen to remove most of the methanol, then finally under vacuum (0.1 torr, 60° C.) for 5 hours to yield 18.26 g of the desired resin.

### PSQAC2CA

A mixture of Lithium 3-bromopropionic acid (6.93 g, 42 mmol), and PSDA (10.00 g, 40 mmol) was stirred at 80° C. in dimethylformamide (DMF) (35 ml) overnight. The solid material was isolated by vacuum filtration, washed with water (3×20 ml), methanol (2×15 ml), and dried under vacuum (0.1 torr), at 65° C. to yield 11.96 g. (68%) of the title resin.

### PSQAC3CA

A mixture of PSDA (45.00 g, 180 mmol), 4-bromobutyrate (36.20 g, 200 mmol), DMF (180 ml), and a catalytic amount of tetra-n-butylammonium iodide (0.96 g, 2.6 mmol) was stirred at 90° C. for 40 hours. The resin was filtered off, washed with methanol (3×60 ml), and dried under a flow of nitrogen. The crude solid was stirred with a solution of KOH (12.0 g) in 250 ml of water for 7 hours before it was isolated by filtration. Subsequently, the resin was washed with water (3×100 mL), and methanol (2×75 mL) and then dried under vacuum (0.1 torr) at 60° C. for 5 hours to yield 58.1 g of the titled resin.

### PSIM

A mixture of potassium Imidazole (22.16 g, 180 mmol), PSCM (40.0 g, 157 mmol), NMP (170 ml), and a catalytic amount of tetra-n-butylammonium iodide (0.96 g, 2.6 mmol) was stirred at 90° C. for 40 hours. The resulting resin was isolated by vacuum filtration, washed with water (3×70 ml) and methanol (2×70 ml), initially dried under a flow of nitrogen, then under vacuum (0.1 torr) at 65° C. for 5 hours to yield 45.44 g (96%) of the PSIM resin.

### PSIMC2SA

A mixture of PSIM (10.0 g, 30.5 mmol), sodium 2-bromoethanesulfonate (8.44 g, 40 mmol), a catalytic amount of KI (1%), and NMP (45ml) was stirred at 85-90° C. overnight. After the reaction mixture was cooled to room temperature, the solid material was filtered off, washed with water (3×30 ml), methanol (2×20 ml), and dried under vacuum (0.1 torr), at 65° C. for 8 hours to yield 12.08 g (62%) of the title resin.

### PSIMC3SA

The titled resin was synthesized according to the procedure used for PSQAC3SA, using PSIM and 1,3-propane sultone with 85% yield (based on PSCM).

### PSIMC1CA

A mixture of PSIM (10.0 g, 30.5 mmol), t-butyl bromoacetate (6.94 g, 33 mmol), and DMF (30 ml) was stirred at 75° C. for 8 hours. The resin was filtered off, washed with methanol (3×20 ml), and dried under a flow of nitrogen. Subsequently, the resin was stirred vigorously at room temperature in a mixture of dioxane (15 ml) and 10 N HCl (8 ml) for 6-10 hours to hydrolyze the ester group. The resin was isolated by filtration, washed with water (3×20 ml), and methanol (2×20 ml), and dried initially for 30 minutes on a filtration funnel under a gentle vacuum. The obtained material was then stirred with a solution of 10% K2CO3 (80 ml) for 30 minutes before it was isolated by filtration and washed with water (3×20 ml) and methanol (2×20 ml). The final product was initially dried under a flow of nitrogen to remove most of the methanol, and finally under vacuum (0.1 torr, 60° C.) to yield 11.69 g of the desired resin.

PSIMC2CA

A mixture of lithium 3-bromopropionic acid (6.96 g, 40 mmol), PSIM (10.0 g, 30.5 mmol), and a catalytic amount of tetra-n-butylammonium iodide (0.37 g, 1.0 mmol) was stirred at 90° C. in DMF (50 ml) for 40 hours. The resulting resin was isolated by vacuum filtration, washed with water (3×70 ml) and methanol (2×70 ml), initially dried under a flow of nitrogen, and finally under vacuum (0.1 torr) at 65° C. for 5 hours to yield 11.67 g (74%) of the title material.

### PSIMC3CA

A mixture of PSIM (44.0 g), methyl 4-bromobutyrate (34.0 g), tetra-n-butylammonium iodide (0.3 g), and DMF (180 mL) was stirred at 90° C. for 40 hours. The resulting resin was isolated by vacuum filtration, washed with methanol (3×70 ml), and dried under a flow of nitrogen. The crude solid was stirred with a solution of KOH (11.0 g) in 250 ml of water for 7 hours before it was isolated by filtration. Subsequently, the resin was washed with water (3×100 mL), and methanol (2×75 mL) and dried under vacuum (0.1 torr) at 60° C. for 5 hours to yield 66.41 g of the titled resin.

### ZIC Column Characterization

Column packing: Each resin was first soaked in ultra pure water (UPW) and sonicated for 30 minutes to remove any air or impurities from the particle pore phase. The resins were then sieved (140 mesh) to remove fines and agglomerates. After sieving, the remaining resin was transferred to a 100 mL beaker and mixed with water to form a 60% (v/v) slurry. Two Omnifit columns (i.d. 1 cm×Lc 15 cm) were connected using an adapter and the bottom plunger was attached with a plug. The resin slurry was poured into the column until both columns were near full. The top plunger was affixed, and the assembly was allowed to settle for at least an hour before running 2 mL/min of UPW through the assembly to further pack down the resin. After the resin height stabilized, the top column and adapter were removed, and the top plunger was affixed to the top of the bottom column. The column was then connected to AKTA and flushed with UPW at 7 mL/min until the conductivity readings lowered to less than 0.01 mS/cm. After the column was cleaned, the top plunger was adjusted down to fix the column length.

Porosity measurement: The columns packed with zwitterionic resins were first characterized with pulse tests using a tracer to determine the bed porosity and total porosity. Since most widely used tracers can interact with either acidic or basic groups of stationary zwitterions, a method to measure the porosity for ZIC has not been reported. 1 However, since the porosities are critical for chromatographic process modeling, an accurate porosity measurement is needed. Thus, the selection of tracers was important. We found that PEG8000 and Dextran T2000 do not interact with the ZI stationary phase and are fully size-excluded from both the QA-based and IM-based resins. Thus, the bed porosities for QA-based and IM-based columns were measured with PEG8000 and Dextran T2000, respectively. UV 190 nm data was used to find the elution volume at the center of mass (VCM). For the total porosity measurement, D20 and 30% ethanol were used as non-retained small tracers for QA-based and IM-based columns, respectively. The effluents were collected, and each fraction was analyzed with FT-IR. The absorbance at 2500 cm−1 was used to measure the D2O concentration. For instance, the QAC3CA column shows that the bed porosity and the total porosity were measured as 0.37 and 0.61, respectively, from the pulse tests (FIG. S7). Using these values, the intraparticle porosity was calculated as 0.38 from Eq. (1). The packed column size, its bed, intraparticle, and total porosities of all ZI columns are summarized in Table S2.

Salt elution test on ZI column: Salt retention on packed ZI columns was measured with a pulse test. To approximate the same convection time through columns of different lengths, the flowrate was fixed at either 0.7 or 2 mL/min for short (6-9 cm) or long (25-29 cm) columns, respectively. A 10 g/L pulse of each salt, LiCl, NaCl, KCl, CaCl2, and MgCl2, was injected from a sample loop (0.5 mL) into each ZI column and eluted with water. The elution profile was monitored with the conductivity signal. After eluting each salt, the column was cleaned by flushing with water until the conductivity returned below 0.1 mS/cm. For multicomponent separations, pulses of mixed salt solutions were injected and eluted with water. A mixture of five salts (5 g/L each, 0.5 mL) or 10 g/L NaCl and LiCl (6 mL) were injected into the QAC3CA column and eluted with water at 2 mL/min, respectively. Similarly, a pulse of 5 g/L of the five salts (0.5 mL) was loaded on the IMC3CA column and separated with water elution. For brine loading tests, 0.5 mL of Smackover brine was loaded on the IMC3CA column and eluted with water at 2 mL/min. Another loading test was conducted by loading the pretreated brackish water (60 mL, 5 mL/min) onto the QAC3CA column where the four identical columns (i.d. 1 cm, length 27 cm) were connected in series, 108 cm of the total column length. The column effluents were collected periodically and analyzed to generate chromatograms.

Disclosed herein are new DLE methods and resins useful for mineral fractionation using the ZIC process. To develop an efficient Li separation, we designed new ZI stationary phases and tested the salt elution on ZIC. Thirteen different ZI resins were prepared from commercially available resins. Salt elution tests on each ZI column showed that salt retention under water elution was significantly affected by the resin pore size, ZI functional groups, and the carbon spacing between ZI groups. A small pore size (less than 10 Å) with ZI functional groups has a synergistic effect on the salt elution profiles because of a high surface density of ZI groups at or on the pores. For instance, QAC3SA showed a size exclusion of divalent salts and QAC3CA showed a unique elution profile for monovalent salts and high selectivity between LiCl and NaCl. Both QAC3CA and IMC3CA were selected as promising ZI groups for separating Li from brines because of high Li selectivity over Na, or Mg and Ca, respectively. QAC3CA showed an efficient separation of LiCl from NaCl yielding a 14.7% recovery of 99.2% purity of LiCl with water elution. Separation of Li from brackish water on QAC3CA yielded 79.2% Li recovery at 99.0% purity of Li over Mg and Ca. The lifetime of QAC3CA is expected to be similar to or longer than that of commercial anion exchange resins. Lastly, simulation studies qualitatively show that the salt elution mechanism on ZIC is related to the hydration reactions of ions in the mobile phase in smaller pore size than 20 Å. However, this ZIC model needs to be developed for further detailed analysis.

For extracting Li from the unconventional Li resources, in an embodiment, a continuous ZIC process using an SMB is contemplated. A successful continuous ZIC operation is hypothesized to isolate Li-rich fractions from brines to achieve a high (>95%) recovery yield based on the results reported in this manuscript. Additionally, this process could be applicable in commercially available desalination processes for post-concentration and water recovery steps.

The foregoing discussion and examples have been presented for purposes of illustration and description. The foregoing is not intended to limit the aspects, embodiments, or configurations to the form or forms disclosed herein. In the foregoing detailed description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method for the separation of salts from an aqueous solution comprising the steps of using simulated moving bed (SMB) chromatography and the use of zwitterionic resins.

2. The method of claim 1 wherein the salts comprise different salts.

3. The method of claim 2 wherein the different salts are separated from each other.

4. The method of claim 3 wherein the salts comprise LiCl.

5. The method of claim 3 wherein the salts comprise LiCl, CaCl₂ and MgCl₂.

6. The method of claim 1 wherein the zwitterionic resins comprise quaternary ammonium cations.

7. The method of claim 1 wherein the zwitterionic resins comprise imidazolium cations.

8. The method of claim 1 wherein the zwitterionic resins comprise anions selected from the group consisting of CO₂, SO₃ and PO₃.

9. The method of claim 1 wherein the zwitterionic resins are selected from the group consisting of QAC2SA, QAC3SA, QAC4SA, QAC1CA, QAC2CA, QAC3CA, IMC1CA, IMC2CA, IMC3CA, IMC2SA, and IMC3SA.

10. A method for the isolation of salt free water from a salt containing solution comprising the separation of salts from the salt containing solution comprising the steps of using simulated moving bed (SMB) chromatography and the use of zwitterionic resins.

11. The method of claim 10 wherein the zwitterionic resins comprise quaternary ammonium cations.

12. The method of claim 10 wherein the zwitterionic resins comprise imidazolium cations.

13. The method of claim 10 wherein the zwitterionic resins comprise anions selected from the group consisting of CO₂, SO₃ and PO₃.

14. The method of claim 11 wherein the zwitterionic resins are selected from the group consisting of QAC2SA, QAC3SA, QAC4SA, QAC1CA, QAC2CA, QAC3CA, IMC1CA, IMC2CA, IMC3CA, IMC2SA, and IMC3SA.

15. A composition of matter comprising zwitterionic resins comprising quaternary ammonium cations, imidazolium cations and further comprising anions.

16. The composition of matter of claim 15 comprising zwitterionic resins comprising anions selected from the group consisting of CO₂, SO₃ and PO₃.

17. The composition of matter of claim 15 comprising zwitterionic resins selected from the group consisting of QAC2SA, QAC3SA, QAC4SA, QAC1CA, QAC2CA, QAC3CA, IMC1CA, IMC2CA, IMC3CA, IMC2SA, and IMC3SA.
